(19) United States
(12) Patent Application Publication
(10) Pub. No.: US 2003/0053450 A1
(43) Pub. Date: Mar. 20, 2003

(54) Layer 2-VPN relay system

(76) Inventors: Makoto Kubota, Kawasaki (JP); Tetsumei Tsuruoka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/116,931

(22) Filed: Apr. 5, 2002

(30) Foreign Application Priority Data
Sep. 18, 2001 (JP) 2001-283477

(51) Int. Cl. H04L 12/66

(52) U.S. Cl. 370/356

(57) ABSTRACT

An MAC frame inputted from a port (in a line accommodation unit) to which a local private network is connected, is further inputted to an L2 forwarding unit 7. It is judged where the received MAC frame should be transferred by referring to a VPN definition table 3 or an L2 route table 6, and the MAC frame is outputted to a local port or is transmitted to an MPLS network after attaching a label to the MAC frame. If a transmission destination is not obtained, the MAC address of the received MAC frame and an input port are related and the correspondence is stored in a route registration unit for later bridging. Alternatively, the MAC frame is broadcast to all the ports other than the receiving port.

### BACKGROUND OF THE INVENTION

1. Field of the Invention

The present invention relates to a VPN (Virtual Private Network) relay system through a public network.

2. Description of the Related Art

Recently, an enterprise and the like have increasingly organized a virtual network (VPN) by connecting bases scattered across the country through the Internet. With this trend, the number of carrier networks/provider networks providing VPM connection service has been increasing.

There are currently two VPN connection forms: a form where bases are connected using a layer 3 (hereinafter called a “layer 3-VPN”) and a form where bases are connected using a layer 2 (hereinafter called a “layer 2-VPN”).

In a layer 3-VPN, bases are connected using a layer 3, while in a layer 2-VPN, bases are connected using a layer 2.

In a layer 2-VPN, since bases can be connected without limiting a protocol to a layer 3 protocol that is used within a VPN, a more flexible virtual network can be organized compared with a layer 3-VPN network. Therefore, it is anticipated that both a demand for a layer 2-VPN and a demand for a technology for implementing a high-speed layer 2-VPN in the IP network or MPLS network, each of which is infrastructure for the existing Internet, of a carrier/provider and the like will increase in the future.

Existing technologies for enabling a layer 2-VPN are described below.

L2TP (Layer 2 Tunneling Protocol)

An L2TP is a protocol in which a VPN can be organized in an IP network by encapsulating a frame by the header of a PPP/L2TP/UDP. Since a PPP is a protocol in which a variety of layer 3 frames and a MAC frame can be encapsulated, a layer 2-VPN can be implemented by using this protocol.

However, since L2TP requires a complex process, for example, L2TP requires sequence number management, it is not recommended to apply L2TP to a high-speed network for a carrier/provider and the like.

VLAN (Virtual LAN) Configuration Using Layer 2-Switch

A VLAN is a protocol in which a VPN can be divided into each LAN by encapsulating the frame by the header of a VLAN and inserting a VID, which is an identifier for identifying VLAN, in the header. A layer 2-VPN can be implemented by using this protocol.

However, since a VLAN operates in a lower-order layer than an IP, a VLAN cannot be used in an IP.

LANE (LAN Emulation)

LANE is a technology for emulating a LAN in an ATM. However, since LANE operates only in an ATM, LANE cannot be applied to a carrier network organized by a network other than an ATM.

As described above, neither of the protocols described above can implement a high-speed layer 2-VPN in a carrier network organized by MPLS (Multi-Protocol Label Switching) or an IP. Specifically, since an L2TP cannot operate at high speed because of a complex process and operates in a lower-order layer than an IP layer in a VLAN (a VLAN described below is a VLAN protocol stipulated in IEEE802.1Q) or LANE, a VPN cannot be organized by utilizing the protocol of an IP network.

### SUMMARY OF THE INVENTION

It is an object of the present invention to implement a VPN for connecting sites at high speed using a layer 2 in a network organized by an IP or MPLS.

The relay system of the present invention organizes a VPN by connecting the first and second layer 2 networks through a public network. The system comprises a connection establishment unit establishing an MPLS connection by relating the first layer 2 network to the second layer 2 network, a storage unit storing the correspondence between the first layer 2 network connected to the system and the MPLS connection, a transmitting unit obtaining an MPLS connection for transmitting a frame from the storage unit upon receipt of the frame from the first layer 2 network and transmitting the frame to the MPLS connection and a broadcasting unit broadcasting the frame when an MPLS connection corresponding to the frame received from the first layer 2 network is not stored in the storage unit.

According to the present invention, since an MPLS, which is a protocol accepted in the market as means compatible with an IP protocol, which is a Internet protocol, for improving IP relay speed, is used and the number of processes needed for the relay is minimized, a VPN relay system that can use an MPLS relay device, which is infrastructure for IP relay, can be organized.

### BRIEF DESCRIPTION OF THE DRAWINGS

FIG. 1 shows the configuration of both the layer 2-VPN implementation device and edge node in the first preferred embodiment of the present invention (No. 1);

FIG. 2 shows the configuration of both the layer 2-VPN implementation device and edge node in the first preferred embodiment of the present invention (No. 2);

FIG. 3 shows the configuration of both the layer 2-VPN implementation device and edge node in the second preferred embodiment of the present invention (No. 1);

FIG. 4 shows the configuration of both the layer 2-VPN implementation device and edge node in the second preferred embodiment of the present invention (No. 2);

FIG. 5 shows the learning function of the preferred embodiment of the present invention (No. 1);

FIG. 6 shows the learning function of the preferred embodiment of the present invention (No. 2);

FIG. 7 shows the learning function of the preferred embodiment of the present invention (No. 3);

FIG. 8 shows the learning function of the preferred embodiment of the present invention (No. 4);

FIG. 9 shows the learning function of the preferred embodiment of the present invention (No. 5);

FIG. 10 shows the learning function of the preferred embodiment of the present invention (No. 6);

FIG. 11 shows the learning function of the preferred embodiment of the present invention (No. 7);

FIG. 12 shows a specific example of the first preferred embodiment (No. 1);

FIG. 13 shows a specific example of the first preferred embodiment (No. 2);

FIG. 14 shows a specific example of the first preferred embodiment (No. 3);

FIG. 15 shows a specific example of the first preferred embodiment (No. 4);

FIG. 16 shows a specific example of the first preferred embodiment (No. 6);

FIG. 18 shows a specific example of the first preferred embodiment (No. 7);

FIG. 19 shows a specific example of the first preferred embodiment (No. 8);

FIG. 20 shows a specific example of the first preferred embodiment (No. 9);

FIG. 21 shows a specific example of the first preferred embodiment (No. 10);

FIG. 22 shows a specific example of the first preferred embodiment (No. 11);

FIG. 23 shows a specific example of the first preferred embodiment (No. 12);

FIG. 24 is a sequence chart showing the process for establishing an LSP in the specific example of the first preferred embodiment;

FIG. 25 is a sequence chart showing frame forwarding (No. 1);

FIG. 26 is a sequence chart showing frame forwarding (No. 2);

FIG. 27 shows a label table 10 to be generated on a forwarding plane when establishing a VPN connection LSP 20;

FIG. 28 shows an LSP backward conversion table 25 generating a control plane;

FIG. 29 shows both edge-connection LSP1 and VPN-connection LSP 20 that are established to organize the VPN shown in FIG. 12;

FIG. 30 is a sequence chart showing the process for establishing an LSP in the specific example of the second preferred embodiment;

FIG. 31 is a sequence chart showing frame forwarding (No. 1);

FIG. 32 is a sequence chart showing frame forwarding (No. 2);

FIG. 33 is a sequence chart showing the process for establishing an LSP in the specific example of the third preferred embodiment;

FIG. 34 is a sequence chart showing frame forwarding (No. 1); and

FIG. 35 is a sequence chart showing frame forwarding (No. 2).

### DESCRIPTION OF THE PREFERRED EMBODIMENTS

In the following description, a VPN connecting sites at high speed in a network organized by an IP or MPLS is called a “layer 2-VPN”.

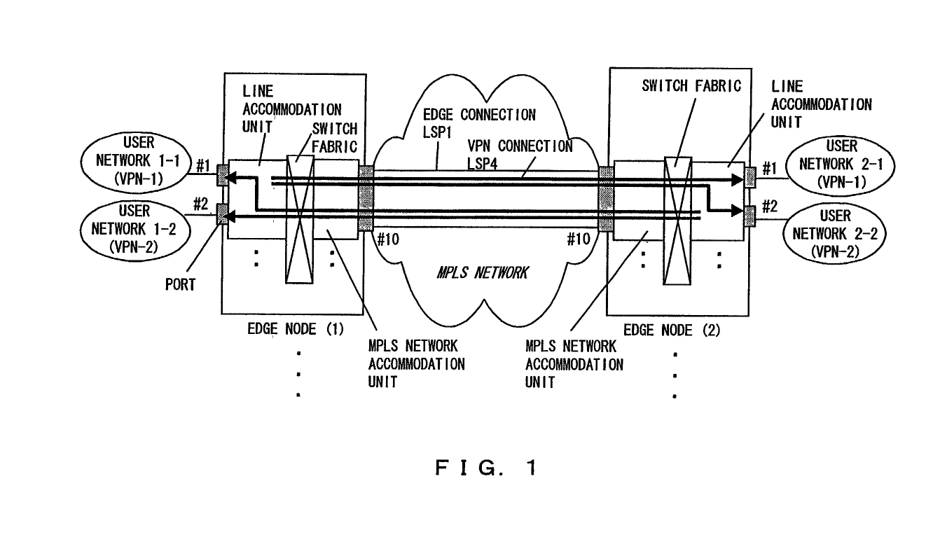

In the following description, it is assumed that like the edge node (1) shown in FIG. 1, an edge node comprises a switch fabric and one or more port accommodation units accommodating a port, and that each accommodation unit is connected to the switch fabric. A port accommodation unit connected to a user network (private network) and a port accommodation unit connected to an MPLS network are called a “line accommodation unit” and an “MPLS network accommodation unit”, respectively.

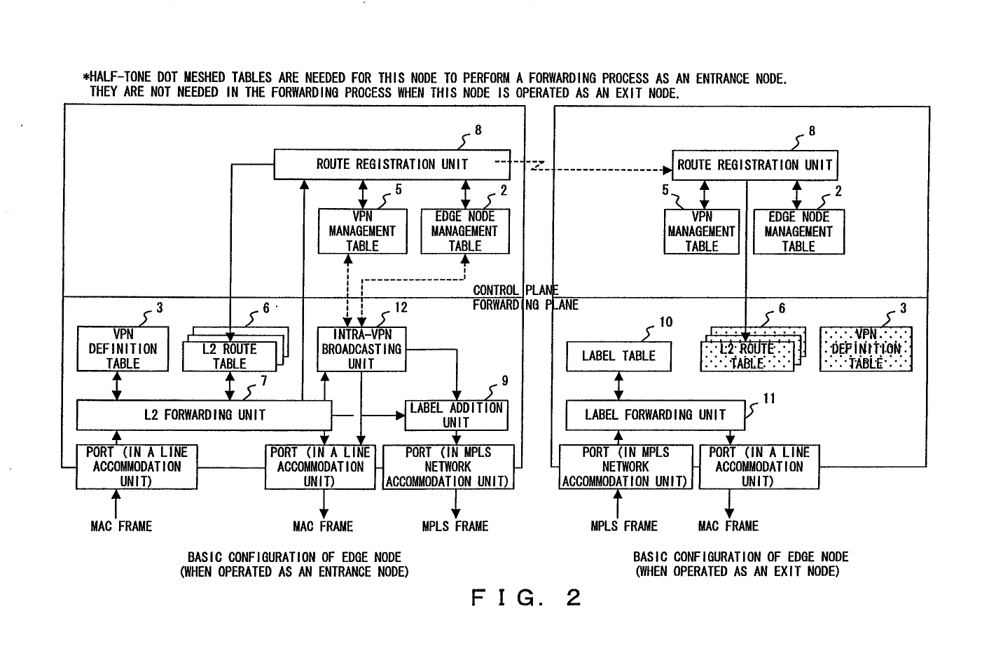

FIGS. 1 and 2 show the configuration of both the layer 2-VPN implementation device and edge node in the first preferred embodiment of the present invention.

Specifically, FIG. 1 shows LSPs (MPLS connections) established between the edge nodes of an MPLS network in the layer 2-VPN relay system. FIG. 2 shows the basic configuration of the edge node shown in FIG. 1. FIG. 2 shows both the configuration of a node at the entrance (hereinafter simply called an “entrance node”) of an MPLS network, which receives a frame from a user network and the configuration of a node at the exit (hereinafter simply called an “exit node”) of the MPLS network relaying the frame received from the entrance node through the MPLS network to a user network.

FIG. 1 shows a state where a connection is established between edge nodes (1) and (2), which are entrance and exit nodes, respectively. An edge node comprises a line accommodation unit, a switch fabric, which is a connection device for switching over a line and an MPLS network accommodation unit. In FIG. 1, an LSP between edge nodes is established between the line accommodation unit of each edge node and the output port of another edge node. Specifically, when establishing an LSP, the line accommodation unit of each edge node is set as a transmission source and the port of the other edge node is designated as a transmission destination.

An edge connection LSP1, which is an MPLS path, is established between edge nodes, and a VPN connection LSP4, which is a path between the line accommodation unit of an entrance node and the port of an exit node, is established in the edge connection LSP1. In this case, an MPLS is compatible with an IP protocol, which is an Internet protocol, and is a protocol accepted in the market as means for improving an IP relay speed.

An edge connection LSP is an LSP (MPLS connection) reciprocally established between edge nodes. An edge connection LSP is established in full mesh between all the edges using an existing protocol for LSP establishment, such as an LDP (Label Distribution Protocol).

The edge node management table 2 shown in FIG. 2 manages edge connections LSP1 established by each edge node. Specifically, the edge management table 2 manages the layer 3 address of an LSP connection destination edge, a transmitting label for an edge connection LSP1 and information about the edge connection LSP1, such as an output port for the edge connection LSP and the like.

A VPN definition table 3 defines a VPN belonging to each port (a physical interface or a logical interface bundling a plurality of physical interfaces is called a “port” hereinafter).

The VPN connection LSP4 shown in FIG. 1 is established between each line accommodation unit of an edge node and a port in the line accommodation unit of another edge node in the MPLS network.

Using the VPN management table 5 shown in FIG. 2, each edge node manages ports in a network belonging to each VPN. Specifically, each edge node manages both all ports in a network belonging to each VPN and a list of the layer 3 addresses of edge nodes accommodating the ports. If the list includes a port in another edge node, each edge node manages a transmitting label for the LSP as information about a VPN connection LSP4 for the port.

Using the L2 route table 6 shown in FIG. 2, each edge node manages routes for a node with an MAC address (the address of a layer 2 protocol used in a private network connected to an edge node). This table is logically divided for each VPN. If the output destination is a local port (port of the line accommodation unit of a local node), the identifier of the port is registered as route information. If the output destination is the port of another edge node, information about both the VPN connection LSP4 and edge connection LSP1 of the output destination (a transmitting label, an output port and the like) are registered.

The L2 forwarding unit 7 shown in FIG. 2 checks whether a pair of the transmission source MAC address (hereinafter called “transmission source MAC”) and receiving port of a frame is already learned as a route and determines a route based on a transmission destination MAC address (hereinafter called “transmission destination MAC”). Specifically, upon receipt of a frame, the unit 7 obtains a VPN corresponding to the receiving port from a VPN definition table 3 and retrieves data from an L2 route table 6 for the VPN using a transmission source MAC. If the retrieval mishits, the unit 7 judges that the route is not registered, and notifies a route registration unit 8 of the route non-registration.

The L2 forwarding unit 7 further retrieves data from the table using the transmission destination MAC and obtains information about an output destination, specifically, a local port or information about both the VPN connection LSP4/edge connection LSP1 of an output destination. If the retrieval mishits, the unit 7 transfers the frame to an intra-VPN broadcasting unit 12, which is described later.

If the output destination is a local port, the L2 forwarding unit 7 transmits the frame to the port. If the output destination is an LSP, the unit 7 transfers the frame to a label addition unit 9.

A route registration unit 8 registers a pair of the transmission source MAC and receiving port in the L2 route table 6 for a VPN corresponding to the port as a new route using the route non-registration notice from the L2 forwarding unit 7 as a trigger.

Furthermore, the route registration unit 8 obtains a list of all the edge nodes accommodating a port for the VPN from the VPN management table 5 and notifies the route registration unit 8 of each edge node of a combination of the identifier of the VPN, the transmission source MAC, the identifier of the receiving port and the layer 3 address of the edge node as a new route.

Upon receipt of the notice, each edge node obtains information about a VPN connection LSP4 corresponding to the notified port and information about an edge connection LSP1 corresponding to the notified layer 3 address (IP address) from the VPN management table 5 and edge node management table 2, respectively, and registers both pieces of information in the L2 route table 6.

The label addition unit 9 attaches a label to the frame, based on information obtained from the L2 route table 6. A label table 10 designates both a route for each received label and a relay process, such as the label operation (hereinafter addition/deletion/replacement called a “label operation”) of a frame with a label, a transmitting label, subsequent hop information and the like. The label table 10 of the exit node of the VPN also designates both an output destination port and label deletion.

A label forwarding unit 11 refers to the label table 10 for a frame received from a port in an MPLS network accommodation unit using the label of the frame, performs the label operation of the frame based on the obtained information and outputs the frame to an output port. The exit node of a VPN deletes the label according to the table.

The intra-VPN broadcasting unit 12 broadcasts the frame to all the ports, excluding a receiving port, of the VPN. Specifically, the unit 12 obtains a list of ports in the VPN from the VPN management table 5 and simultaneously, broadcasts the frame to both all local ports for the VPN and the port of another edge node for the VPN. When transmitting the frame to the port of another edge node, the unit 12 further also refers to the edge node management table 2 and obtains information about both the VPN connection LSP4 and edge connection LSP1 of the output destination. If the output destination is a local port, the unit 12 transmits the frame without performing any other process. If the output destination is an LSP, the unit 12 transfers the frame to the label addition unit 9.

The frame is reproduced by a prior art, such as a processor, a broadcasting server and the like. If a broadcasting server is used, the server can also be installed outside an edge node.

However, this broadcasting is performed only when the route registration unit 8 does not store the destination of the received MAC frame in the L2 route table 6. This is because in this state it is unknown where this MAC frame should be transmitted. Therefore, in this case, the MAC frame is transmitted to all the transmission destination ports of the VPN.

This preferred embodiment presumes a network in which both an existing IP routing protocol, such as a BGP, an OSPF and the like, and an existing MPLS control protocol, such as an LDP and the like, are operated and each edge node can be connected to each other in an IP or MPLS. First, in preparation for frame relay, the device of this preferred embodiment defines a VPN and establishes an LSP between edge nodes. Specifically, the following operations are performed.

The existing LSP establishment unit, such as an LDP and the like establishes an edge connection LSP1 for inter-connecting edge nodes and registers information about the edge connection LSP1, such as a layer 3 address (IP address), a transmitting label for the edge connection LSP1, an output port and the like, in the edge node management table 2 for each connection destination. The node of an MPLS network registers both a route for each label and the label operation in the label table 10.

After relating each port in the line accommodation unit of a local node (hereinafter called a “local port”) to a VPN and registering the correspondence in the VPN definition table 3, each edge node obtains information about the correspondence between each of ports accommodated by another edge node and the VPN by prescribed negotiation and establishes an LSP (VPN connection LSP4) between each line accommodation unit accommodating a port belonging to the VPN and all the ports of another edge node belonging to the same VPN as a VPN accommodated by a local edge node.

When establishing an LSP, each edge node registers a list of the ports of another edge node, information about a VPN connection LSP4 corresponding to each port and a list of the ports of a local edge node in the VPN management table 5 for each VPN.

Simultaneously, each edge node generates the label table 10 designating the label deletion of the established VPN connection LSP4 by another edge node.

After the preparation described above, upon receipt of a frame from a local port, each edge node performs the following frame relay operations.

(1) After identifying a VPN corresponding to the receiving port using the VPN definition table 3, the L2 forwarding unit 7 retrieves data from a L2 route table 6 for the VPN using the transmission source MAC of the frame as a key.

If the retrieval hits, the unit 7 performs process (2).

If the retrieval mishits, the unit 7 notifies the route registration unit 8 of the route non-registration. Upon receipt of the notice, the unit 8 registers a pair of the transmission source MAC and receiving port in an L2 route table 6 for a VPN corresponding to the port. Simultaneously, the unit 8 obtains a list of edge nodes with a port belonging to the same VPN as the VPN from the VPN management table 5 and notifies each edge node of the combination of the identifier of the VPN, the transmission source MAC, the identifier of the receiving port and the layer 3 address of the edge node as the new route of the VPN.

Upon receipt of the notice, each edge node refers to both the VPN management table 5 and edge node management table 2 based on the notified content, obtains information about an edge connection LSP1 for the layer 3 and registers the information in a L2 route table 21 for each VPN together with the notified content.

(2) The L2 forwarding unit 7 further retrieves data from the L2 route table 6 corresponding to the VPN using the transmission destination MAC of the frame as a key.

If the retrieval hits, the unit 7 obtains information about the output destination from the table. If the output destination is a local port, the information is about the identifier of the port. If the output destination is an LSP, the information is about both transmitting labels for edge connection LSP1/VPN connection LSP4 and an output port.

If the retrieval mishits, the intra-VPN broadcasting unit 12 obtains a list of output destination local ports in the VPN and information about output destination VPN connection LSP4/edge connection LSP1 from the VPN management table 5 and edge node management table 2, respectively, and broadcasts the frame to each output destination.

(3) Furthermore, if the output destination is a local port, the L2 forwarding unit 7 transmits the frame to the port. If the output destination is an LSP, the label addition unit 9 adds transmitting labels for edge connection LSP/VPN connection LSP and transmits the frame to the LSP.

Upon receipt of the frame from the port of an MPLS network accommodation unit, each edge node performs the following relay operation.

(4) A label forwarding unit 11 refers to the label table 10 using the label of the frame, deletes the label of the frame according to the obtained information and outputs the frame to an output port.

As described above, the device of this preferred embodiment can perform address learning by a transmission source MAC, route determination by a transmission destination MAC and broadcasting within the VPN at the time of transmission destination MAC non-learning, and thereby a layer 2-VPN can be organized.

Since the forwarding plane process is a simple process for referring to a table using the parameter with a fixed length of the frame and performing both direction determination and header addition/deletion, the speed of the process can be easily improved.

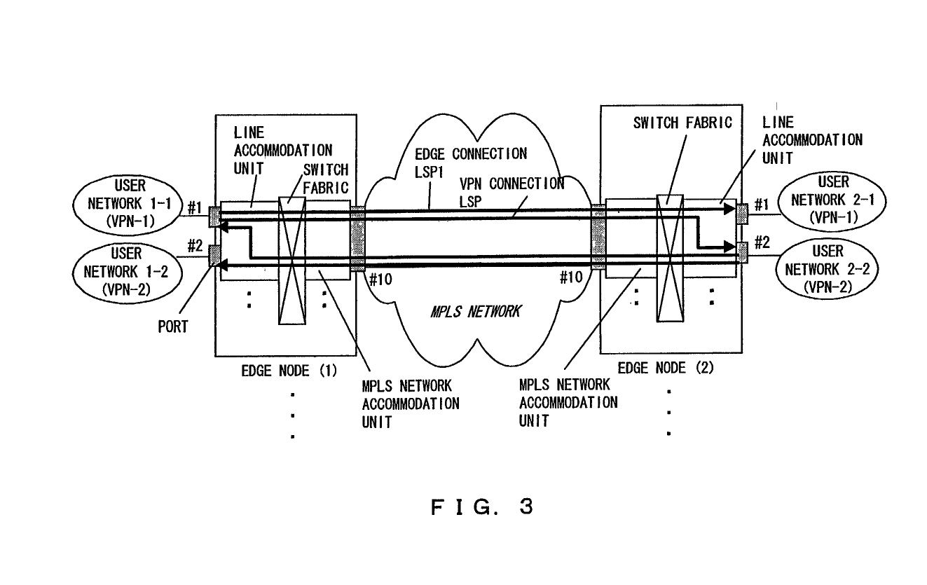

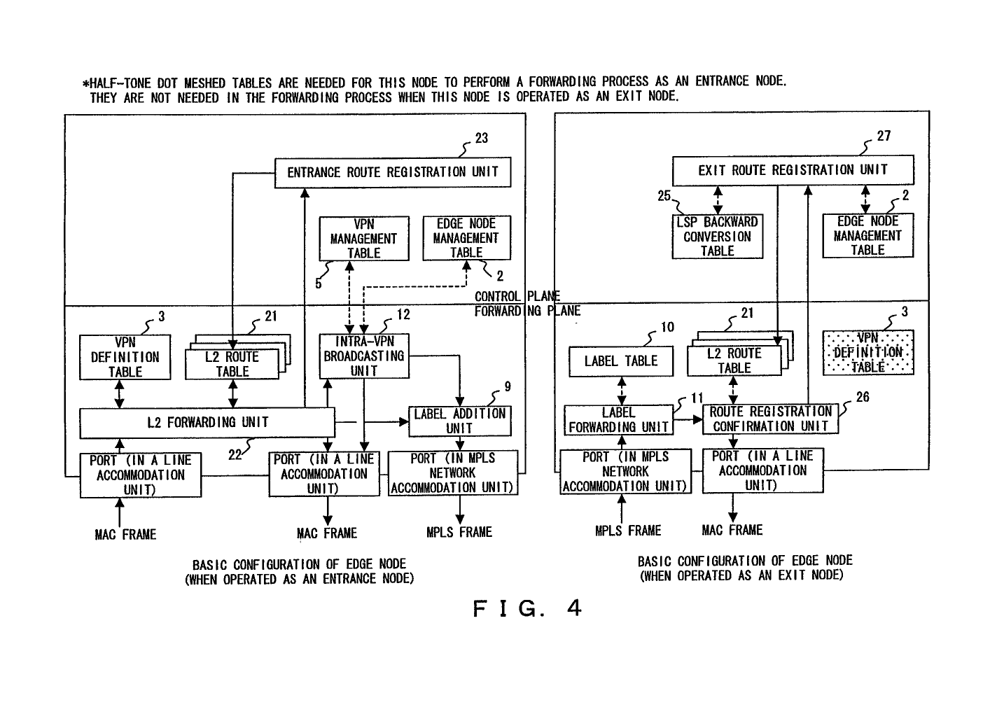

FIGS. 3 and 4 show the configuration of both the layer 2-VPN implementation device and edge node in the second preferred embodiment of the present invention. Specifically, FIG. 3 shows LSPs established between the edge nodes of an MPLS network in the layer 2-VPN system of the present invention. FIG. 4 shows the basic configurations of the edge nodes shown in FIG. 3 and shows both the configuration of a node at the entrance (hereinafter simply called an “entrance node”) of an MPLS network that receives a frame from a user network and the configuration of a node at the exit (hereinafter simply called an “exit node”) of the MPLS network relaying the frame received from the entrance node through the MPLS network to the user network.

Only parts different from the first preferred embodiment are described below.

A VPN connection LSP20 is reciprocally established in full mesh between a port of each line accommodation unit of an edge node and a port of the line accommodation unit of an edge node in the MPLS network.

Using an L2 route table 21, each edge node manages a route for an edge node with an MAC address. In this preferred embodiment, this table is logically divided for each port. If an output destination is a local port, the identifier of the port is registered as route information. If the output destination is the port of another edge node, information about the VPN connection LSP20/edge connection LSP1 of the output destination (a transmitting label, an output port and the like) are registered.

An L2 forwarding unit 22 checks whether a pair of the transmission source MAC address (hereinafter called “transmission source MAC”) and receiving port of a frame is already learned as a route and determines a route based on a transmission destination MAC address (hereinafter called “transmission destination MAC”).

Specifically, upon receipt of a frame, the unit 22 obtains a VPN corresponding to the receiving port from the VPN definition table 3 and retrieves data from an L2 route table 21 for a receiving port using a transmission source MAC. If the retrieval mishits, the unit 22 judges that the route is not registered, and notifies an entrance route registration unit 23 of the route non-registration.

The L2 forwarding unit 22 further retrieves data from the table using a transmission destination MAC and obtains information about an output destination, specifically, a local port or information about both the VPN connection LSP20/edge connection LSP1 of an output destination. If the retrieval mishits, the unit 22 transfers the frame to an intra-VPN broadcasting unit 12.

If the output destination is a local port, the L2 forwarding unit 22 transmits the frame to the port without performing any other process. If the output destination is an LSP, the unit 22 transfers the frame to a label addition unit 9.

An entrance route registration unit 23 registers a pair of the transmission source MAC and receiving port in an L2 route table 21 for a VPN corresponding to the port as a new route using the route non-registration notice from the L2 forwarding unit 22 as a trigger.

An LSP backward conversion table 25 is a table by which each edge node relates a VPN connection LSP 20 for a local port from a port in another edge node to information about the backward VPN connection LSP 20 and edge connection LSP1.

A route registration confirmation unit 26 retrieves data from an L2 route table 21 for an output port using the transmission source MAC of the frame. If the retrieval mishits, the unit 26 notifies an exit route registration unit 27 of the route non-registration.

The exit route registration unit 27 registers a route for an edge node with the transmission source MAC using the route non-registration notice from the route registration confirmation unit 26 as a trigger. Specifically, the unit 27 obtains the VPN connection LSP 20 and edge connection LSP1, which are the return routes of the received VPN connection LSP 20 from the LSP backward conversion table 25, by referring to the LSP backward conversion table 25 based on the receiving label of the frame, and registers the connections in the L2 route table 21 for an output destination port.

As in the preferred embodiment previously described, in the device of this preferred embodiment, both an existing IP routing protocol, such as a BGP, an OSPF and the like, and an existing MPLS control protocol, such as an LDP and the like, are operated, and each edge node can be connected to each other in an IP or MPLS.

First, in preparation for frame relay, the device of this preferred embodiment defines a VPN and establishes an LSP between edge nodes. Specifically, the following operations are performed.

The existing LSP establishment unit, such as an LDP and the like, establishes an edge connection LSP1 for inter-connecting edge nodes and registers information about an edge connection LSP1, such as a layer 3 address, a transmitting label for an edge connection LSP1, an output port and the like, in the edge node management table 2 for each connection destination edge node. A node in an MPLS network registers both a route for each label and the label operation in the label table 10.

After relating each port of the line accommodation unit of a local node (hereinafter called a “local port”) to a VPN and registering this correspondence in the VPN definition table 3, each edge node obtains information about the correspondence between each of ports accommodated by another edge node and the VPN by prescribed negotiation by prescribed negotiation, and establishes an LSP (VPN connection LSP20) between each local port belonging to the VPN and all the ports of another edge node belonging to the same VPN as the VPN accommodated by each local node.

When establishing an LSP, each edge node registers a list of ports in another edge node, information about a VPN connection LSP20 corresponding to each port and a list of ports in a local edge node in the VPN management table 5 for each VPN.

Simultaneously, each edge node generates the label table 10 designating the label deletion of a VPN connection LSP20 established by another edge node.

After the preparation described above, upon receipt of a frame from a local port, each edge node performs the following frame relay operations.

(1) After identifying a VPN corresponding to the receiving port using the VPN definition table 3, the L2 forwarding unit 22 retrieves data from the L2 route table 21 for a receiving port using the transmission source MAC of the frame as a key.

If the retrieval hits, the unit 22 proceeds to a subsequent process without performing any other process.

If the retrieval mishits, the unit 22 notifies the entrance route registration unit 23 of the route non-registration. Upon receipt of the notice, the unit 23 registers a pair of the transmission source MAC and receiving port in an L2 route table 21 for the port.

(2) The L2 forwarding unit 22 further retrieves data from a L2 route table 21 corresponding to the VPN using the transmission destination MAC of the frame as a key.

If the retrieval hits, the unit 22 obtains information about an output destination from the table. If the output destination is a local port, the information is about the identifier of the port. If the output destination is an LSP, the information is about both transmitting labels and an output port for edge connection LSP1 and VPN connection LSP4.

If the retrieval mishits, the intra-VPN broadcasting unit 12 obtains both a list of ports in the VPN from the VPN management table 5 and broadcasts the frame to both all local ports for the port and the VPN connection LSP20.

(3) Furthermore, if the output destination is a local port, the L2 forwarding unit 22 transmits the frame to the port. If the output destination is an LSP, the label addition unit 9 adds transmitting labels for edge connection LSP and VPN connection LSP to the frame and then transmits the frame to the LSP.

Upon receipt of the frame from the port of an MPLS network accommodation unit, each edge node performs the following relay operations.

(1) A label forwarding unit 23 refers to the label table 10 based on the label of the frame and determines an output port. Simultaneously, the unit 23 deletes the label of the frame according to the obtained information.

(2) A route registration confirmation unit 26 retrieves data from the L2 route table for an output destination port obtained by the label forwarding unit 23 using the transmission source MAC of the frame after label deletion as a key. If the retrieval hits, the unit 23 outputs the frame without performing any other process.

If the retrieval mishits, the unit 23 notifies the exit route registration unit 27 of the route non-registration. Upon receipt of the notice, the exit route registration unit 27 obtains the VPN connection LSP 20 and edge connection LSP1, which are the return routes of the received VPN connection LSP 20 from the LSP backward conversion table 25, and registers the connections in the L2 route tables 21 for the VPN in a pair with the notified transmission source MAC.

As described above, since the device of the second preferred embodiment according to the present invention can perform address learning by a transmission source MAC, route determination by a transmission destination MAC and broadcasting within the VPN at the time of transmission destination MAC non-learning, a layer 2-VPN can be organized.

Since the forwarding plane process is a simple process for referring to a table using the parameter with a fixed length of the frame and performing both direction determination and header addition/deletion, the speed of the process can be easily improved.

The third preferred embodiment is described below.

An L2 forwarding unit 31 checks whether a pair of the transmission source MAC address (hereinafter called “transmission source MAC”) and receiving port of a frame is already learned as a route and determines a route based on a transmission destination MAC address (hereinafter called “transmission destination MAC).

Specifically, upon receipt of a frame, the unit 31 obtains a VPN corresponding to the receiving port from the VPN definition table 3 and retrieves data from an L2 route table 21 for a receiving port using a transmission source MAC. If the retrieval mishits, the unit 31 judges that the route is not registered, and notifies a route registration unit 32 of the route non-registration.

The L2 forwarding unit 31 further retrieves data from the table using the transmission destination MAC and obtains information about an output destination, specifically, a local port or information about the VPN connection LSP20 and edge connection LSP1 of an output destination. If the retrieval mishits, the unit 31 transfers the frame to an intra-VPN broadcasting unit 12.

If the output destination is a local port, the L2 forwarding unit 31 transmits the frame to the port without performing any other process. If the output destination is an LSP, the unit 31 transfers the frame to a label addition unit 9.

The route registration unit 32 registers the pair of the transmission source MAC and receiving port in an L2 route table 21 for a VPN corresponding to the port as a new route using route the non-registration notice from the L2 forwarding unit 7 as a trigger.

Furthermore, the route registration unit 32 obtains a list of the layer 3 addresses of all edge nodes accommodating the port for the VPN from the VPN management table 5 and notifies each edge node of a combination of the identifier of the VPN, the transmission source MAC, the identifier of the receiving port and the layer 3 address of the edge node as a new route.

Upon receipt of the notice, each edge node obtains information about a VPN connection LSP4 corresponding to the notified port and information about edge connection LSP1 corresponding to the notified layer 3 address from the VPN management table 5 and edge node management table 2, respectively, and registers both pieces of information in the L2 route table 6.

Since both an existing IP routing protocol, such as a BGP, an OSPF and the like, and an existing MPLS control protocol, such as an LDP and the like, are operated, the device of this preferred embodiment can be implemented presuming a network in which edge nodes can be connected to each other in an IP or MPLS.

First, in preparation for frame relay, the device of this preferred embodiment defines a VPN and establishes an LSP. Specifically, the following operations are performed.

The existing LSP establishment unit, such as an LDP and the like, establishes an edge connection LSP1 for inter-connecting edge nodes, between edge nodes and registers information about the edge connection LSP1, such as a layer 3 address, a transmitting label for the edge connection LSP1, an output port and the like, in the edge node management table 2 for each connection destination edge node. A node in an MPLS network registers both a route for each label and the label operation in the label table 10.

After relating each port of the line accommodation unit in a local node (hereinafter called a “local port”) to a VPN and registering this correspondence in the VPN definition table 3, each edge node obtains information about the correspondence between each of ports accommodated by another edge node and the VPN by some negotiation, and establishes an LSP (VPN connection LSP20) between each local port belonging to the VPN and all the ports of another edge node belonging to the same VPN as the VPN accommodated by a local node.

When establishing an LSP, each edge node registers a list of the ports of another edge node, information about a VPN connection LSP20 corresponding to each port and a list of the ports of a local node, in the VPN management table 5 for each VPN.

Simultaneously, each edge node generates the label table 10 designating the label deletion of the VPN connection LSP20 established by another edge node.

After the preparation described above, upon receipt of a frame from a local port, each edge node performs the following frame relay operations.

(1) After identifying a VPN corresponding to a receiving port using the VPN definition table 3, the L2 forwarding unit 31 retrieves data from the L2 route table 12 for a receiving port using the transmission source MAC of the frame as a key.

If the retrieval hits, the unit 31 proceeds to a subsequent process without performing any other process.

If the retrieval mishits, the unit 31 notifies the route registration unit 32 of the route non-registration. Upon receipt of the notice, the unit 32 registers a pair of the transmission source MAC and receiving port in the L2 route table 21 for a receiving port port. Simultaneously, the unit 32 obtains a list of edge nodes with a port belonging to the same VPN as the VPN from the VPN management table 5 and notifies each edge node of a combination of the identifier of a VPN, the transmission source MAC, the identifier of the receiving port and the layer 3 address of the edge node as a new route of the VPN.

Upon receipt of the notice, each edge node obtains information about edge connection LSP1 for the layer 3 using the notified layer 3 address and registers the information in an L2 route table 21 for each port together with the notified content.

(2) The L2 forwarding unit 31 further retrieves data from a L2 route table 21 corresponding to the VPN using the transmission destination MAC of the frame as a key.

If the retrieval hits, the unit 31 obtains information about the output destination from the table. If the output destination is a local port, the information is about the identifier of the port. If the output destination is an LSP, the information is about both transmitting labels for edge connection LSP1 and VPN connection LSP20 and an output port.

If the retrieval mishits, the intra-VPN broadcasting unit 12 obtains a list of ports in the VPN and information about output destination VPN connection LSP20 and edge connection LSP1 in the VPN from the VPN management table 5 and edge node management table 2, respectively, and broadcasts the frame to both all local ports for the port and the VPN connection LSP20.

(3) Furthermore, if the output destination is a local port, the L2 forwarding unit 31 transmits the frame to the port. If the output destination is an LSP, the label addition unit 9 adds transmitting labels for edge connection LSP and VPN connection LSP, and then transmits the frame to the LSP.

As in the existing MPLS, after sending the frame from an entrance node, a node in the MPLS network, which is not shown in FIGS. 1 and 2, determines path direction, based on the label and relays the frame up to the exit node.

Upon receipt of the frame from the port of an MPLS network accommodation unit, the exit node performs the following frame relay operation.

(4) The label forwarding unit 11 refers to the label table 10, based on the label of the frame, deletes the label of the frame according to the obtained information and outputs the frame to the exit port.

As described above, since the device of the second preferred embodiment according to the present invention can perform address learning by a transmission source MAC, route determination by a transmission destination MAC and broadcasting within the VPN at the time of transmission destination MAC non-learning, a layer 2-VPN can be organized.

Since the forwarding plane process is a simple process for referring to a table using the parameter with a fixed length of the frame and performing both direction determination and header addition/deletion, the speed of the process can be easily improved.

The fourth preferred embodiment is described below.

A VPN definition table 50 relates the VLAN identifier (VID) of a frame to both a VPN and a receiving logical port (a logical port related to a VID is called like this hereinafter).

An L2 forwarding unit 41 checks whether a pair of the transmission source MAC address (hereinafter called “transmission source MAC”) and receiving port of a frame is already learned as a route and determines a route, based on a transmission destination MAC address (hereinafter called “transmission destination MAC”).

Specifically, upon receipt of the frame, the unit 41 obtains a VPN corresponding to the VID of the frame from a VPN definition table 40 and retrieves data from a L2 route table 6 for the VPN using a transmission source MAC. If the retrieval mishits, the unit 41 notifies the route registration unit 8 of the route non-registration.

The unit 41 further retrieves data from the table using the transmission destination MAC and obtains information about an output destination, specifically, a local port or information about the VPN connection LSP4 and edge connection LSP1 of an output destination. If the retrieval mishits, the unit 41 transfers the frame to the intra-VPN broadcasting unit 12.

If the output destination is a local port, the unit 41 transmits the frame to the port without performing any other process. If the output destination is an LSP, the unit 41 transfers the frame to the label addition unit 9.

A label table 42 designates the label deletion of a frame with a label, an output destination port and a VLAN identifier (VID) attached to a frame when outputting the frame.

A label forwarding unit 43 refers to a label table 42 using the label in the frame and deletes the label of the frame, based on the obtained information. Simultaneously, the unit 43 obtains a VLAN identifier to be attached to an output frame, overwrites by the VID to the VLAN header in the frame after a label deletion.

In this case, a network is presumed in which both an existing IP routing protocol, such as a BGP, an OSPF and the like, and an existing MPLS control protocol, such as an LDP and the like, are operated, and each edge node can be connected to each other by an IP or MPLS.

In preparation for frame relay, the device of this preferred embodiment defines a VPN and establishes an LSP. Specifically, the following operations are performed.

The existing LSP establishment unit, such as LDP and the like, establishes an edge connection LSP1 for inter-connecting edge nodes, between edge nodes and registers information about the edge connection LSP1, such as a layer 3 address, a transmitting label for the edge connection LSP1, an output port and the like, in the edge node management table 2 for each connection destination edge node. A node in an MPLS network registers both a route for each label and the label operation in the label table 42.

After relating a VLAN identifier (VID) to a VPN and registering this correspondence in a VPN definition table 40, each edge node establishes an LSP (VPN connection LSP4) between each line accommodation unit of a local node and all the ports of another edge node.

When establishing an LSP, each edge node registers a list of ports in another edge node, information about a VPN connection LSP4 corresponding to each port and a list of ports in a local node in the VPN management table 5 for each VPN.

Simultaneously, each edge node generates the label table 42 designating the label deletion of the VPN connection LSP4 established by another edge node.

After the preparation described above, upon receipt of a frame from a local port, each edge node performs the following frame relay operations.

(1) After identifying a VPN corresponding to the VID of the frame using the VPN definition table 40, the L2 forwarding unit 41 retrieves data from the L2 route table 6 for the VPN using the transmission source MAC of the frame as a key.

If the retrieval hits, the unit 41 proceeds to process (2) without performing any other process.

If the retrieval mishits, the unit 41 notifies the route registration unit 8 of the route non-registration. Upon receipt of the notice, the unit 8 registers a pair of the transmission source MAC and receiving port in an L2 route table 6 for the VPN. Simultaneously, the unit 8 obtains a list of edge nodes with a port belonging to the same VPN as the VPN from the VPN management table 5 and notifies each edge node of a combination of the identifier of the VPN, the transmission source MAC, the identifier of the receiving port and the layer 3 address of the edge node as a new route of the VPN.

Upon receipt of the notice, each edge node registers the notified route in an L2 route table 6.

(2) The L2 forwarding unit 41 further retrieves data from an L2 route table 6 corresponding to the VPN using the transmission destination MAC of the frame as a key.

If the retrieval hits, the unit 41 obtains information about the output destination from the table. If the output destination is a local port, the information is about the identifier of the port. If the output destination is an LSP, the information is about both transmitting labels for edge connection LSP1 and VPN connection LSP20 and an output port.

If the retrieval mishits, the intra-VPN broadcasting unit 12 obtains a list of the output destination local ports in the VPN and information about output destination VPN connection LSP4/edge connection LSP1 from the VPN management table 5 and edge node management table 2, respectively, and broadcasts the frame to each output destination.

(3) Furthermore, if the output destination is a local port, the L2 forwarding unit 41 transmits the frame to the port. If the output destination is an LSP, the label addition unit 9 adds transmitting labels for edge connection LSP and VPN connection LSP, and then transmits the frame.

Upon receipt of the frame from the port of a MPLS network accommodation unit, each edge node performs the following frame relay operation.

(4) The label forwarding unit 43 refers to the label table 42 using the label of the frame and deletes the label of the frame, based on the obtained information. Simultaneously, the unit 43 attaches a VLAN header, including the VID obtained from the table, to the frame and outputs the frame to an output frame.

As described above, since the device of the present invention can perform address learning by a transmission source MAC, route determination by a transmission destination MAC and broadcasting within the VPN at the time of transmission destination MAC non-determined, a VPN connecting VLANs in a layer-2 can be organized.

Since the forwarding plane process is a simple process for referring to a table using the parameter with a fixed length of the frame and performing both direction determination and header addition/deletion, the speed of the process can be easily improved.

The fifth preferred embodiment is described below.

An L2 forwarding unit 52 checks whether a pair of the transmission source MAC address (hereinafter called “transmission source MAC”) and receiving port of a frame is already learned as a route and determines a route, based on a transmission destination MAC address (hereinafter called “transmission destination MAC”).

Specifically, upon receipt of the frame, the unit 52 obtains both a VPN corresponding to the VID of the frame and a receiving logical port from a VPN definition table 50 and retrieves data from an L2 route table 21 for the receiving logical port using a transmission source MAC. If the retrieval mishits, the unit 52 notifies the entrance route registration unit 23 of the route non-registration.

The unit 52 further retrieves data from the table using the transmission destination MAC and obtains information about an output destination, specifically, a logical local port or information about the VPN connection LSP4/edge connection LSP1 of an output destination. If the retrieval mishits, the unit 52 transfers the frame to the intra-VPN broadcasting unit 12, described below.

If the output destination is a logical local port, the unit 52 transmits the frame to the port without performing any other process. If the output destination is an LSP, the unit 52 transfers the frame to the label addition unit 9.

The entrance route registration unit 23 registers a pair of a transmission source MAC and a receiving logical port in an L2 route table 21 for a VPN corresponding to the logical port as a new route using the route non-registration notice from the L2 forwarding unit 52 as a trigger.

In this case, a network is presumed in which both an existing IP routing protocol, such as a BGP, an OSPF and the like, and an existing MPLS control protocol, such as an LDP and the like, are operated, and each edge node can be connected to each other in an IP or MPLS.

In preparation for frame relay, the device of this preferred embodiment defines a VPN and establishes an LSP. Specifically, the following operations are performed.

The existing LSP establishment unit, such as an LDP and the like, establishes an edge connection LSP1 for inter-connecting edge nodes, between edge nodes and registers information about the edge connection LSP1, such as a layer 3 address, a transmitting label for the edge connection LSP1, an output port and the like, in the edge node management table 2 for each connection destination edge node. A node in an MPLS network registers both a route for each label and the label operation in the label table 10.

After relating a VLAN identifier (VID) to both a VPN and a logical port and registering this correspondence in the VPN definition table 50, each edge node establishes an LSP (VPN connection LSP20) between each logical port belonging to the VPN and all the logical ports of another edge node.

When establishing an LSP, each edge node registers a list of logical ports in another edge node, information about a VPN connection LSP20 corresponding to each logical port and a list of logical ports in a local node in the VPN management table 5 for each VPN.

Simultaneously, each edge node generates the label table 10 designating the label deletion of the VPN connection LSP20 established by another edge node.

After an above preparation, the edge node receiving a frame from a logical local port, executes a frame relay operation below.

(1) After identifying a VPN corresponding to the receiving logical port using the VPN definition table 50, the L2 forwarding unit 52 retrieves data from an L2 route table 21 for a receiving logical port using the transmission source MAC of the frame as a key.

If the retrieval hits, the unit 52 proceeds to a subsequent process without performing any other process.

If the retrieval mishits, the unit 52 notifies the entrance route registration unit 23 of the route non-registration. Upon receipt of the notice, the unit 23 registers the pair of the transmission source MAC and receiving logical port in an L2 route table 21 for the logical port.

(2) The L2 forwarding unit 52 further retrieves data from an L2 route table 21 corresponding to the receiving local port using the transmission destination MAC of the frame as a key.

If the retrieval hits, the unit 52 obtains information about an output destination from the table. If the output destination is a logical local port, the information is about the identifier of the port. If the output destination is an LSP, the information is about both transmitting and an output logical port labels for edge connection LSP1 and VPN connection LSP20.

If the retrieval mishits, the intra-VPN broadcasting unit 12 obtains a list of logical ports in the VPN from the VPN management table 5, and broadcasts the frame to both all the logical local ports for the logical port and the VPN connection LSP20.

(3) Furthermore, if the output destination is a local port, the L2 forwarding unit 52 transmits the frame to the port. If the output destination is an LSP, the label addition unit 9 adds transmitting labels for edge connection LSP and VPN connection LSP, and then transmits the frame to the LSP.

Upon receipt of the frame from the port of an MPLS network accommodation unit, each edge node performs the following frame relay operations.

(4) The label forwarding unit 23 refers to the label table 10 using the label of the frame and deletes the label of the frame, based on the obtained information. Simultaneously, the unit 23 attaches a VLAN header, including the VID obtained from the table, to the frame.

(5) The route registration confirmation unit 26 retrieves data from an L2 route table 21 for an output destination port obtained from the label forwarding unit 23. If the retrieval hits, the unit 26 outputs the frame without performing any other process.

If the retrieval mishits, the unit 26 notifies the exit route registration unit 27 of the route non-registration. Upon receipt of the notice, the exit route registration unit 27 obtains both backward VPN connection LSP20 and edge connection LSP1 that correspond to the received VPN connection LSP 20 from the LSP backward conversion table 25 and registers the connections in the L2 route table 21 for an output port obtained by the label forwarding unit 23 in a pair with the notified transmission source MAC.

As described above, the device of the present invention can perform address learning by a transmission source MAC, route determination by a transmission destination MAC and broadcasting within the VPN at the time of transmission destination MAC non-learning, and a VPN connecting VLANs in a layer 2 can be organized.

Since the forwarding plane process is a simple process for referring to a table using the parameter with a fixed length of the frame and performing both direction determination and header addition/deletion, the speed of the process can be easily improved.

The sixth preferred embodiment is described below.

An L2 forwarding unit 61 checks whether a pair of the transmission source MAC address (hereinafter called “transmission source MAC”) and receiving port of a frame is already learned as a route and determines a route, based on a transmission destination MAC address (hereinafter called “transmission destination MAC”).

Specifically, upon receipt of the frame, the unit 61 obtains both a VPN corresponding to the VID of the frame and a receiving logical port from a VPN definition table 50 and retrieves data from an L2 route table 21 for the receiving logical port using a transmission source MAC. If the retrieval mishits, the unit 61 notifies the route registration unit 8 of the route non-registration.

The unit 61 further retrieves data from the table using the transmission destination MAC and obtains information about output destination, specifically, a local port or information about the VPN connection LSP20 and edge connection LSP1 of an output destination. If the retrieval mishits, the unit 61 transfers the frame to the intra-VPN broadcasting unit 12, which will be described later.

If the output destination is a local port, the unit 61 transmits the frame to the port without performing any other process. If the output destination is an LSP, the unit 61 transfers the frame to the label addition unit 9.

In this case, a network is presumed in which both an existing IP routing protocol, such as a BGP, an OSPF and the like, and an existing MPLS control protocol, such as an LDP and the like, are operated and that each node can be connected to each other in an IP or MPLS.

In preparation for frame relay, the device of this preferred embodiment defines a VPN and establishes an LSP. Specifically, the following operations are performed.

The existing LSP establishment unit, such as an LDP and the like, establishes an edge connection LSP1 for inter-connecting edge nodes, between edge nodes and registers information about the edge connection LSP1, such as a layer 3 address, a transmitting label for the edge connection LSP1, an output port and the like, in the edge node management table 2 for each connection destination edge node. A node in the MPLS network registers both a route for each label and the label operation in the label table 10.

After relating a VLAN identifier (VID) to a VPN and registering this correspondence in the VPN definition table 3, each edge node establishes an LSP (VPN connection LSP20) between each logical port belonging to the VPN and all the logical ports of another edge node.

When establishing an LSP, each edge node registers a list of logical ports in another edge node, information about a VPN connection LSP20 corresponding to each logical port and a list of logical ports in a local node in the VPN management table 5 for each VPN.

Simultaneously, each edge node generates the label table 10 designating the label deletion of the VPN connection LSP20 established by another edge node.

After the preparation described above, upon receipt of a frame from a local port, each edge node performs the following frame relay operations.

(1) After identifying a VPN corresponding to the receiving logical port using the VPN definition table 3, the L2 forwarding unit 61 retrieves data from the L2 route table 21 for receiving port using the transmission source MAC of the frame as a key.

If the retrieval hits, the unit 61 proceeds to a subsequent process without performing any other process.

If the retrieval mishits, the unit 61 notifies the route registration unit 8 of the route non-registration. Upon receipt of the notice, the unit 8 registers the pair of the transmission source MAC and receiving port in an L2 route table 21 for a VPN corresponding to the port. Simultaneously, the unit 61 obtains a list of edge nodes with a port belonging to the same VPN as the VPM from the VPN management table 5 and notifies each edge node of a combination of the identifier of the VPN, the transmission source MAC, the identifier of the receiving port and the layer 3 address of the edge node.

Upon receipt of the notice, each edge node registers the notified route in the L2 route table.

(2) The L2 forwarding unit 55 further retrieves data from an L2 route table 21 corresponding to the VPN using the transmission destination MAC of the frame as a key.

If the retrieval hits, the unit 55 obtains information about the output destination from the table. If the output destination is a local port, the information is about the identifier of the port. If the output destination is an LSP, the information is about both transmitting labels for edge connection LSP1 and VPN connection LSP20 and an output logical port.

If the retrieval mishits, the intra-VPN broadcasting unit 12 obtains a list of ports in the VPN and a list of a plurality pieces of information about output destination VPN connections LSP20/edge connections LSP1 from the VPN management table 5 and edge node management table 2, respectively, and broadcasts the frame to both all the local ports for the port and the VPN connections LSP20.

(3) Furthermore, if the output destination is a local port, the L2 forwarding unit 55 transmits the frame to the port. If the output destination is an LSP, the label addition unit 9 adds transmitting labels for edge connection LSP and VPN connection LSP, and then transmits the frame to the LSP.

Upon receipt of the frame from the port of an MPLS network accommodation unit, each edge node performs the following frame relay operation.

(4) A label forwarding unit 11 refers to the label table 10 using the label of the frame and deletes the label, according to the obtained information. Simultaneously, the unit 11 attaches a VLAN header, including the VID obtained from the table, to the frame and outputs the frame to an output port.

As described above, the device of the present invention can perform address learning by a transmission source MAC, route determination by a transmission destination MAC and broadcasting within the VPN at the time of transmission destination MAC non-learning, and a VPN connecting VLANs in a layer 2 can be organized.

Since the forwarding plane process is a simple process for referring to a table using the parameter with a fixed length of the frame and performing both direction determination and header addition/deletion, the speed of the process can be easily improved.

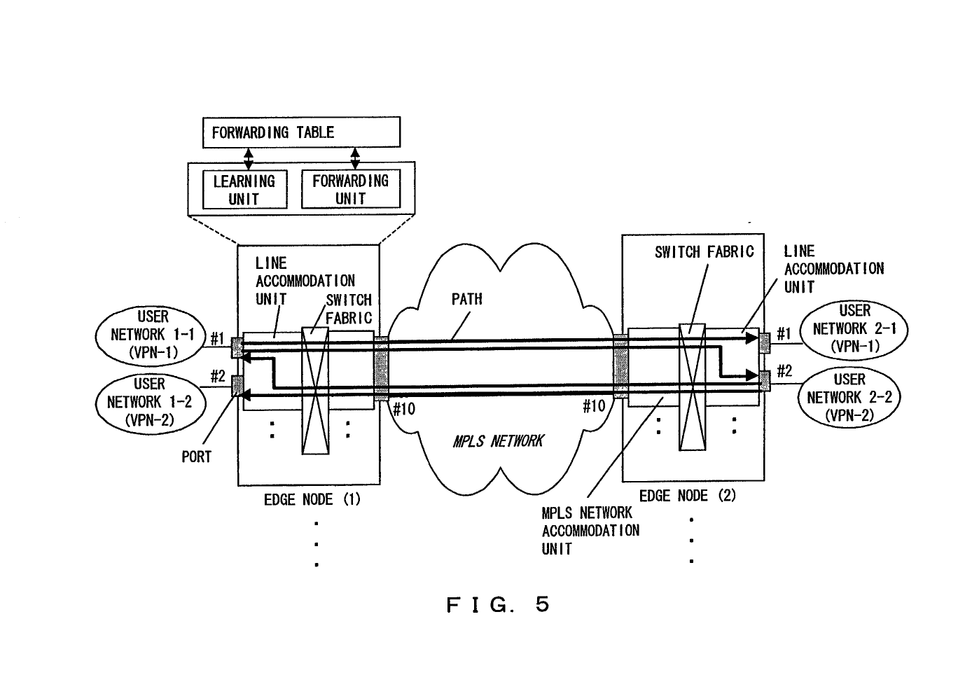

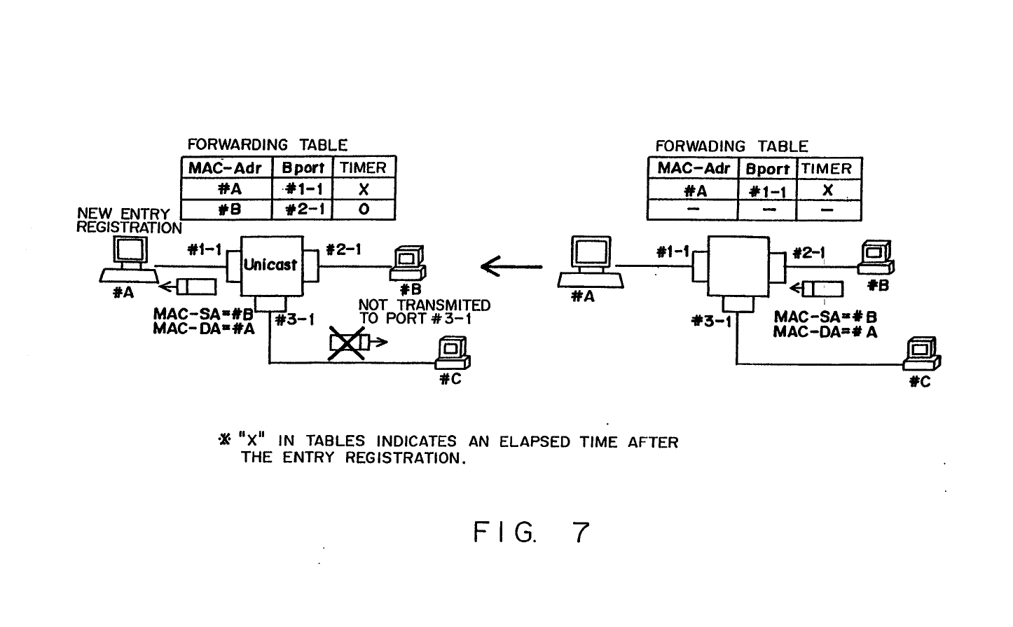

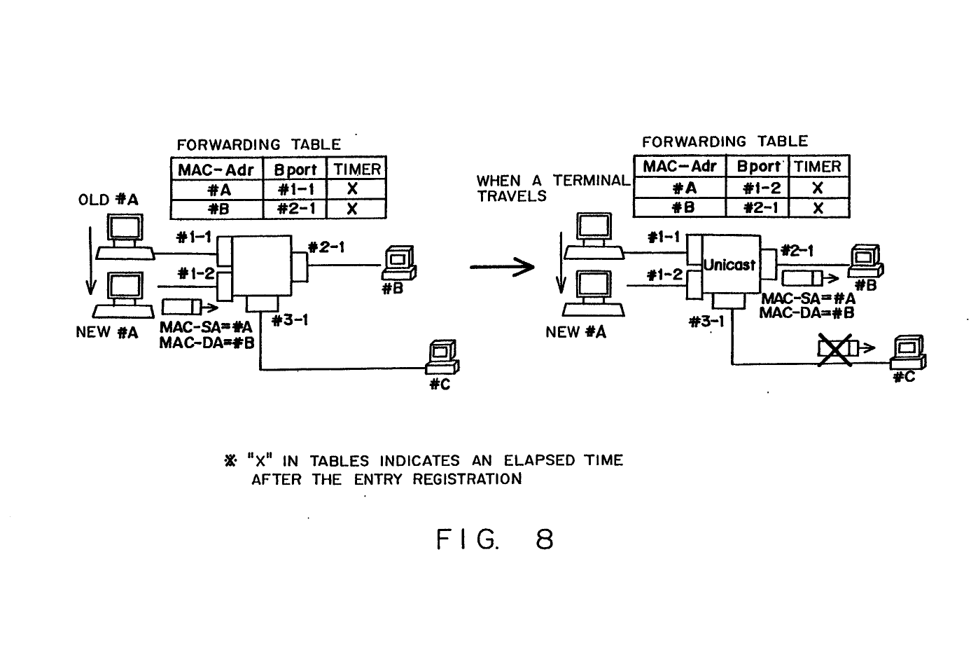

FIGS. 5 through 11 show the learning functions in the preferred embodiments of the present invention.

One of the features of the preferred embodiment of the present invention is the learning function of an MAC address.

Since, as a rule, a bridge (which bridges an edge node between two different networks) is a layer 2 relay device, a relay frame is broadcast within a LAN (specifically, to all the ports). However, upon receipt of a relay target frame, the bridge usually registers in advance a pair of the transmission source MAC address of the frame (temporarily described as MAC#A) and the receiving port of the frame (temporarily described as port#1-1) in a forwarding table as a cache. This means that the bridge has learned that a terminal with MAC#A is accommodated in port#1-1. After this learning, upon receipt of a frame for MAC#A, a frame is unicast and relayed to port#1-1 (instead of broadcasting the frame to all the ports), based on the content stored in the forwarding table.

If a terminal A travels, usually the bridge can update the location information. If terminal A stops or if terminal A seldom communicates, it is the waste of table capacity to continue to store the information of terminal A in the forwarding table. Therefore, timer management is usually applied to this table and information about a terminal transmitting no frame for a specific time period is generally deleted from the table.

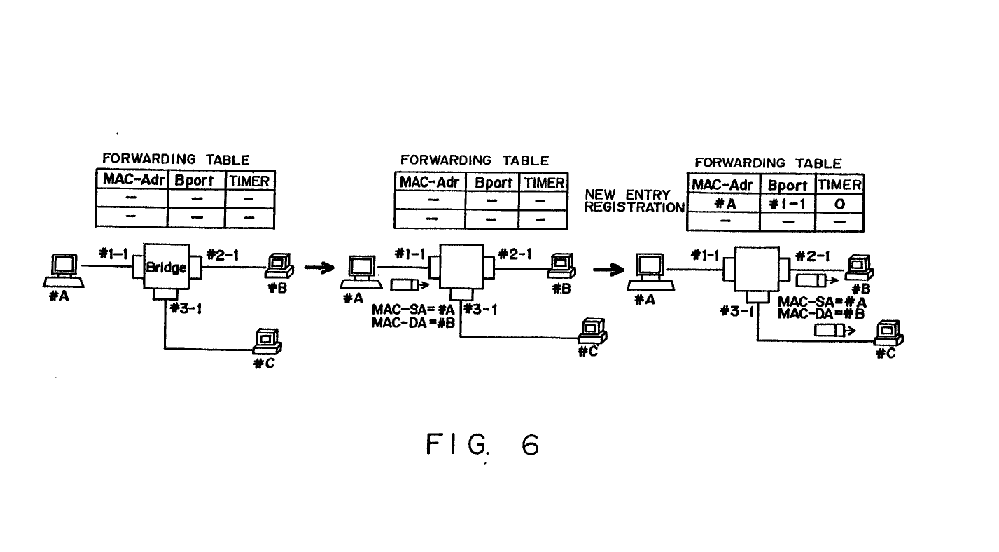

The learning function described above is a prior art, which is shown in FIGS. 6 through 8. However, in a configuration through a core network (MPLS network, etc.) like this preferred embodiment, an existing learning unit cannot be used without modification because of the following problems.

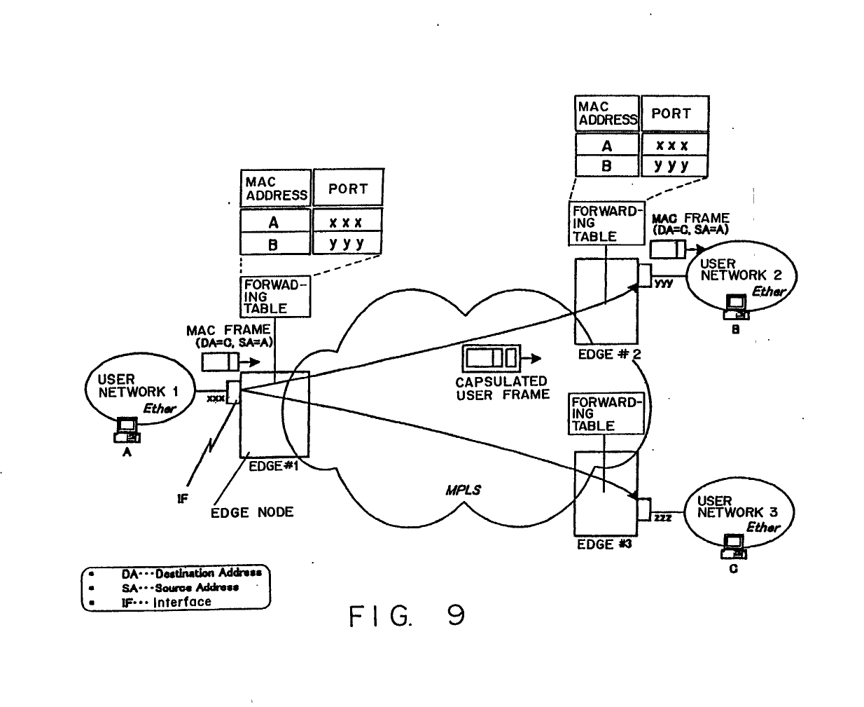

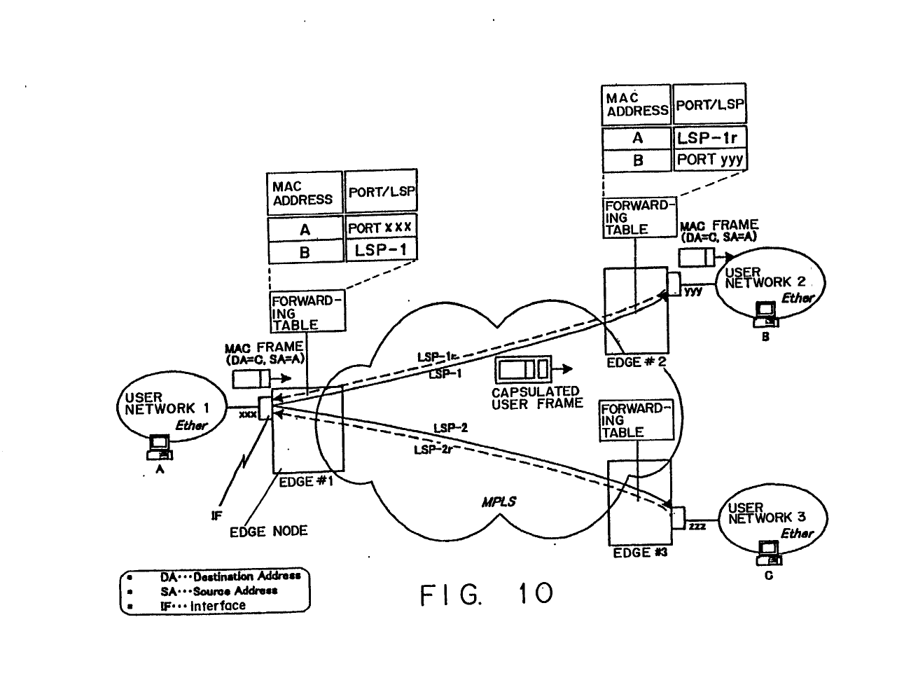

Specifically, although between edges #1 and 2 (see FIG. 9), the port xxx of edge#1 should be learned as location information about terminal A, edge#2 cannot learn port xxx since port xxx belongs to edge#1.

Therefore, in the second preferred embodiment of the present invention, learning by a path (LSP) is applied to edge#2 instead of learning by port xxx receiving a frame.

Specifically, table registration in edge#2 is made as follows.

A pair of the MAC address of terminal A and an LSP established between ports xxx and yyy is registered in a forwarding table. Since the path (LSP) in an MPLS is for one way, the registration in the table must be made paying attention to direction. Table registration in edge#1 can be made as in an existing bridge.

The operation summary of edge#2 receiving a frame from edge#1 through an LSP is as follows.

Edge#2 recognizes the reception of a frame that terminal A transmits to terminal B from LSP-1 (the reception of a frame from LSP-1 can be recognized by a label attached to the frame). When the reception is recognized, a pair of an MAC address and LSP-1r is registered in a table as learning about terminal A. In this case, since LSP-1r is the backward version of LSP-1. This is because an MPLS path is for one way.

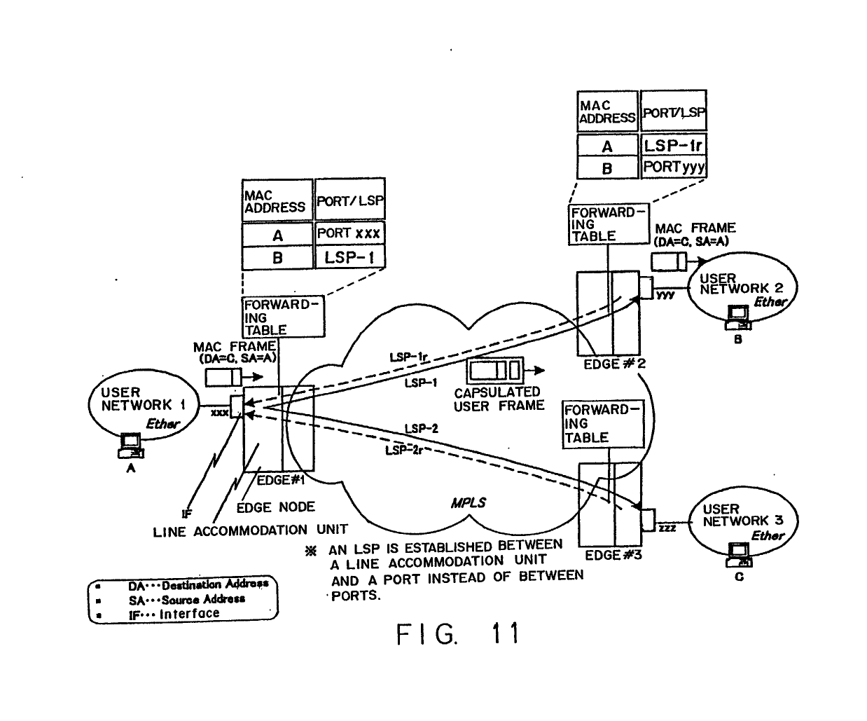

In this way, when receiving a frame for terminal A from terminal B in the future, edge#2 can refer to the forwarding table, can obtain LSP-1r as transmission destination LSP corresponding to MAC-DA (=address #A) and can transmit to the LSP (see FIG. 10).

Learning in the first preferred embodiment is slightly different from the learning described above.

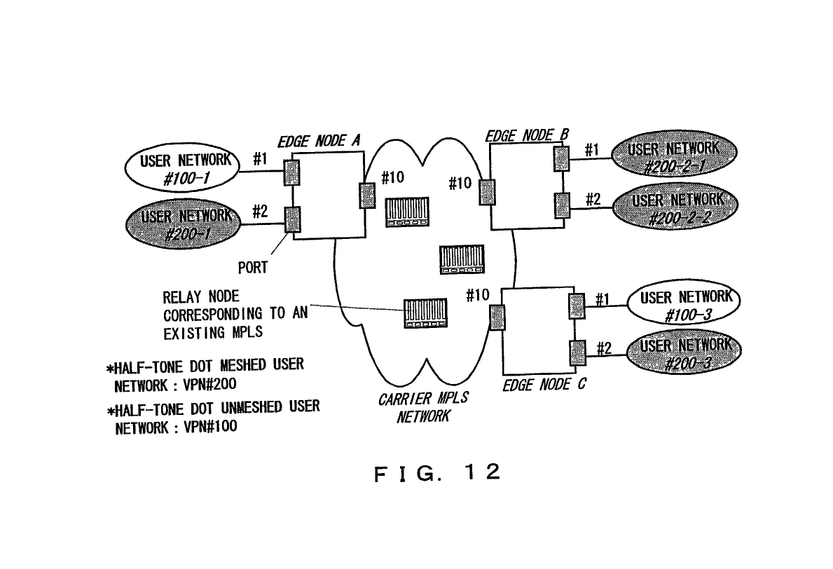

Specifically, table registration in edge#2 is made as follows (see FIG. 11).

A pair of the MAC address of terminal A and an LSP established between a line accommodation unit and port xxx is registered in a forwarding table. Since the MPLS path (LSP) is for one way, the registration in the table must be made paying attention to direction.

The operation summary of edge#2 receiving a frame from edge#1 through an LSP is as follows.

Edge#2 can recognize the reception of a frame for terminal B transmitted from terminal A, from LSP-1. However, since LSP-1 is transmitted from the line accommodation unit of edge#1, edge#2 cannot judge from the frame from which port the frame is transmitted (Since the line accommodation unit accommodates a plurality of ports, edge#2 cannot judge from which port of edge#1 the frame is transmitted).

Therefore, learning about terminal A is performed only in edge#1 and edge#1 notifies edge#2 of the learning content. In other words, learning by a relay frame is not performed in edge#2.

As a result, edge#2 registers the pair of MAC address A and LSP-1r in the table. In this case, LSP-1r is established between the line accommodation unit of edge#2 and the port xxx of edge#1.

In this way, when receiving a frame for terminal A from terminal B in the future, edge#2 can refer to a forwarding table, can obtain LSP-1r as a transmission destination LSP corresponding to MAC-DA (address #A) and can transmit to the LSP.

In the first preferred embodiment, an LSP is established between a line accommodation unit and a port while in the second preferred embodiment, an LSP is established between ports. Therefore, in the first preferred embodiment, the number of required LSPs can be reduced.

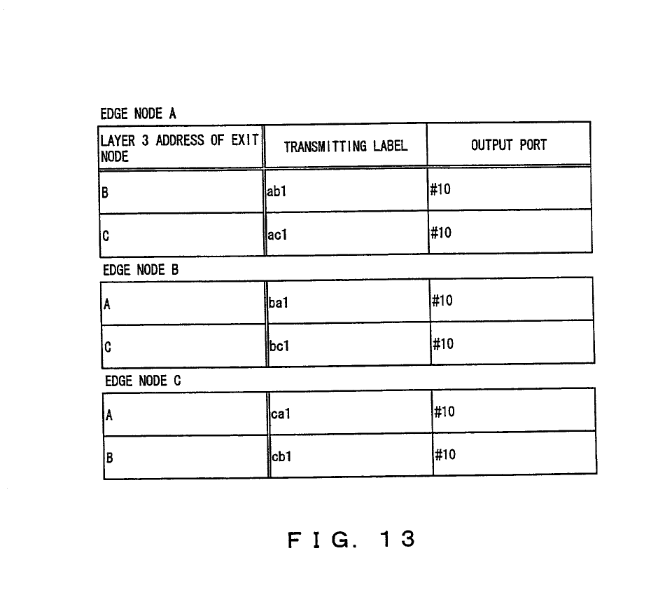

FIGS. 12 through 23 show specific examples of the first preferred embodiment.

As shown in FIG. 12, in this specific example, user networks #100-1 and #100-3 are connected to organize one VPN (VPN#100), and user networks #200-1, #200-2-1, #200-2-2 and #200-3 are connected to organize another VPN (VPN#200). In this case, it is assumed that the layer 3 addresses of edge nodes A, B and C shown in FIG. 12 are A, B and C, respectively.

Hereinafter in this specific example, description will be given assuming that all links between nodes in the carrier MPLS network shown in FIGS. 12 through 23 should be a PPP (the present invention does not restrict a link layer).

VPN Definition and LSP Establishment (Preparation for Frame Relay):

First, the flow of both LSP establishment and VPN definition that are performed in preparation for frame relay between user networks in the layer 2-VPN system of this preferred embodiment is described.

Establishment of Edge Connection LSP

Generation of Edge Node Management Table

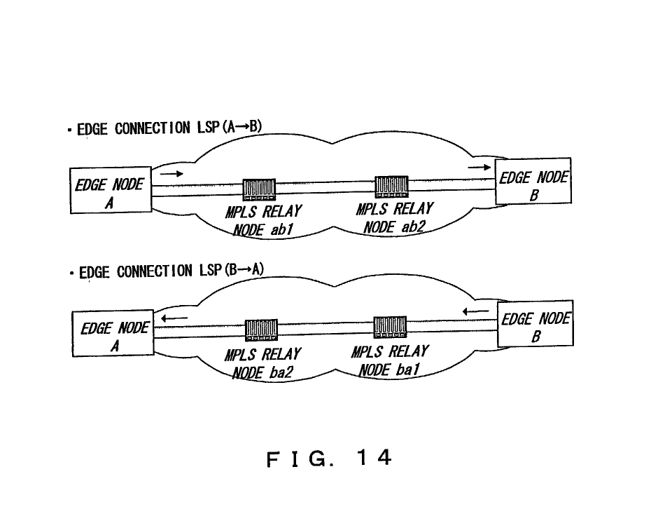

Edge connections LSP1 for inter-connecting edge nodes by an existing LSP establishment unit, such as an LDP and the like, are established between edge nodes A, B and C, and the established LSPs are registered in the edge node management table 2 of a control plane (see FIG. 13).

In the table, both a label to be attached to a frame when the frame is transmitted to the LSP and an output port are registered as LSP parameters. Although a node (node other than an edge node) in an MPLS network also establishes such a table, descriptions of nodes other than edge node A are omitted in FIG. 13.

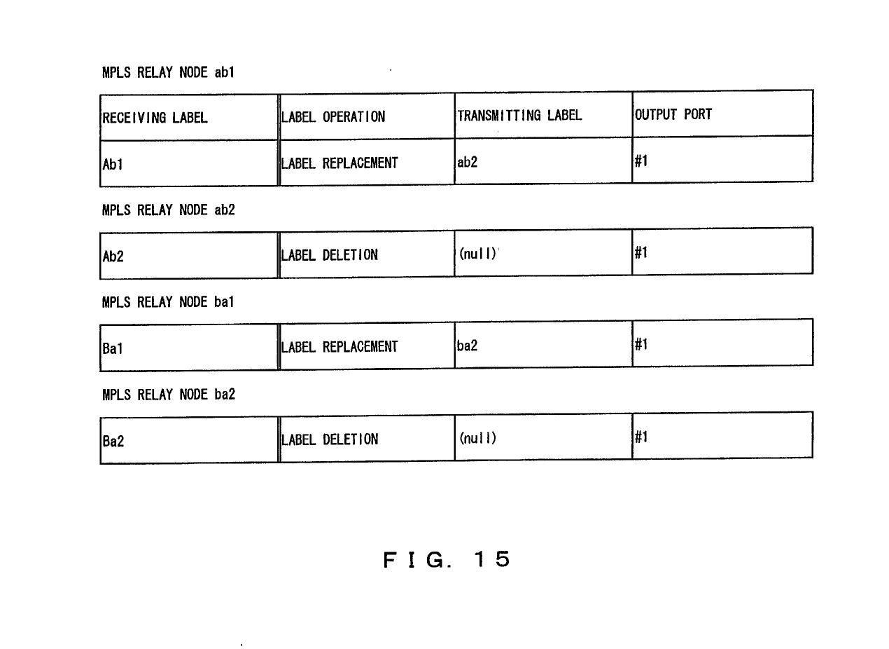

FIG. 14 shows the established edge connection LSP1 (only LSP1 between edge nodes A and B is shown. LSP1 between edges A and C is omitted.)

Generation of Label Table

A node in each MPLS network (both edge nodes and each node in an MPLS network) generates the label table 10 of a forwarding plane based on the established LPSs.

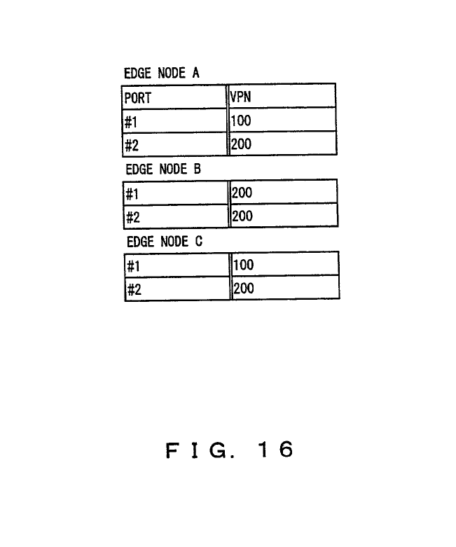

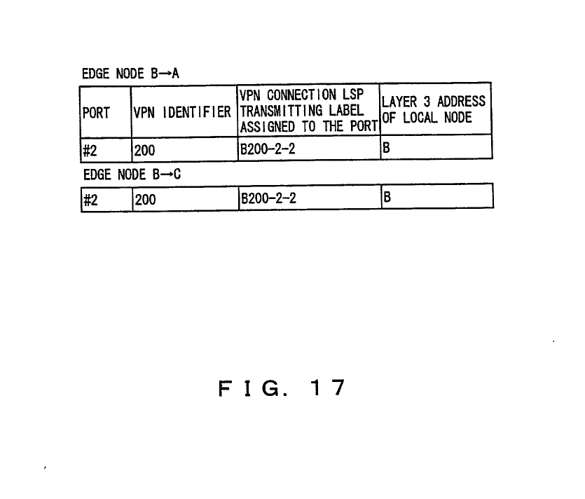

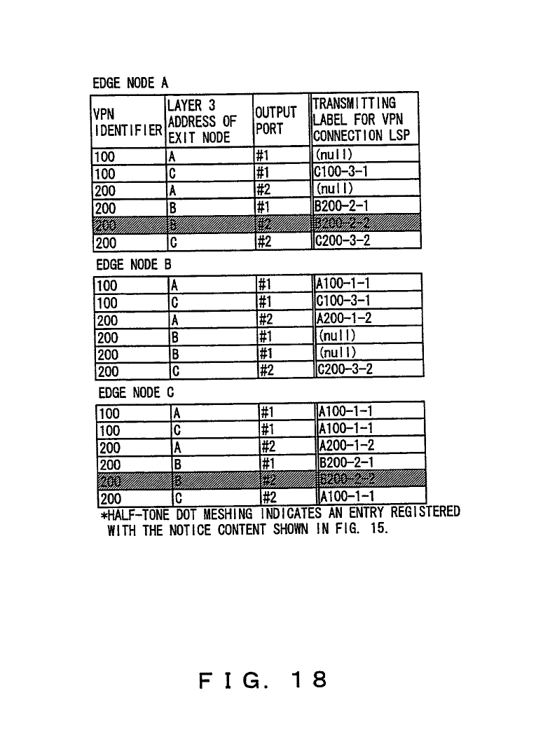

FIG. 15 shows the generated label table 10 (only LSP1 between edge nodes A and B is shown. LSP1 between edges A and C is omitted.)

In FIG. 15, a table such that a label will be deleted in a node immediately before an exit node (MPLS relay nodes ab2 and ba2 shown in FIG. 14) in the LSP is generated. It is one of the specifications of an existing MPLS that a label is deleted in a node immediately before an exit node. Although in some of the existing MPLS specifications, a label is deleted in the exit node, the specific examples of this preferred embodiment and the following examples of the preferred embodiments are described assuming that a label is deleted in a node immediately before an exit node.

VPN Definition and Establishment of VPN Connection LSP:

Generation of VPN Definition Table

A belonging VPN is related to each port in an edge node, based on both the user network and VPN definition shown in FIG. 12. FIG. 16 shows a VPN definition table 3 describing such correspondences.

Establishment of VPN Connection LSP

Each edge node obtains information about the correspondence between ports accommodated by another edge node and a VPN by some negotiation and establishes an LSP (VPN connection LSP4) between each line accommodation unit accommodating a port belonging to the VPN and all the ports in the another node belonging to the same VPN as a VPN accommodated by a local node.

Although in this preferred embodiment, the negotiation and VPN connection LSP4 establishment can be implemented by an arbitrary means, in this example it is assumed that a VPN connection LSP4 should be established by notifying all the edge nodes connected by edge connection LSP1 as follows.

Content of Notification (FIG. 17):

A combination of the identifier of a local port in each node, a VPN to which the port belongs, a transmitting label for a VPN connection LSP4 assigned to the port and the layer 3 address of a local node. B

Notification Means

An existing MPLS-VPN control protocol newly defined so as to include the combination described above as a control message.

FIG. 17 shows an example of notice message (an example of a notice about the port#2 of edge node B).

Each of the notified edge nodes A, B and C establishes a VPN connection LSP 4 between each line accommodation unit accommodating a port belonging to the VPN and all the ports of another node belonging to the same VPN as a VPN accommodated by a local node. The established VPN connection LSP 4 is stored in a VPN management table 5 (FIG. 18).

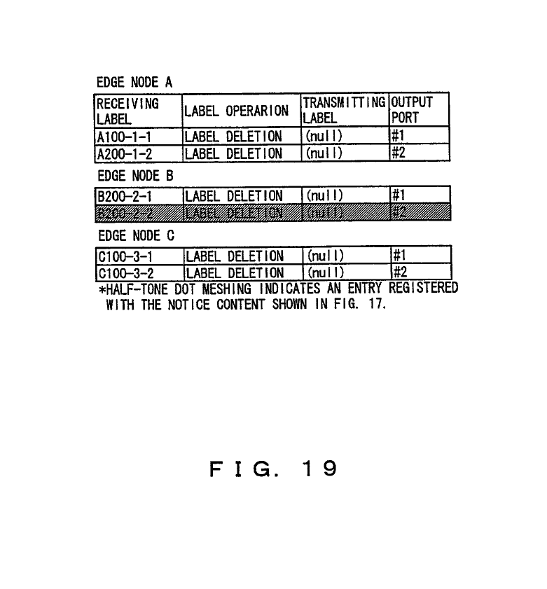

FIG. 19 shows a label table 10 generated in a forwarding plane when a VPN connection LSP4 is established.

Although in this example it is assumed that the label table of an exit node is referenced only once at the time of relay, in an MPLS network where both a VPN connection LSP label and an edge node connection LSP label are stacked and relayed from the entrance node of an MPLS network to the exit node, each edge node can also independently prepare a table corresponding to each stack of the labels and can refer to each table at the time of relay.

If the device includes a plurality of line accommodation units/MPLS network accommodation units and if the plurality of accommodation units are connected in an exit node by a switch fabric, a relay form/table arrangement such that a label table can also be referenced in a receiving MPLS network accommodation unit, the label of a frame can also be replaced with a forwarding label for an accommodation unit on the output side of the device and the label table can also be referenced again in the accommodation unit on the output side.

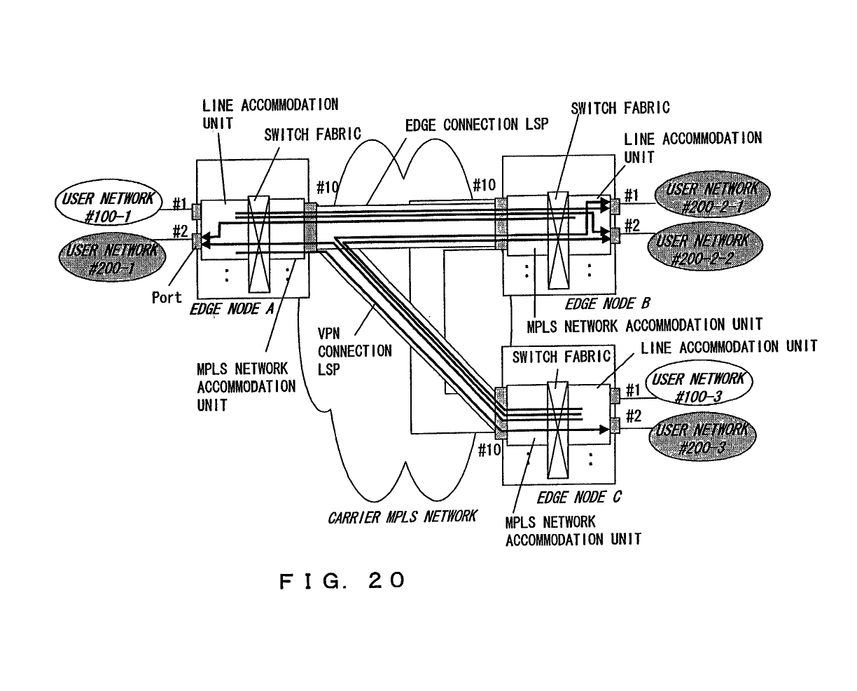

FIG. 20 shows both the edge connection LSP1 and VPN connection LSP4 generated by the processes described above to organize the VPN shown in FIG. 12. In FIG. 20, only LSPs used to organize VP#200 are described and LSPs used to organize VPN#100 are omitted.

MAC Frame Relay Process in Entrance Node (Edge Node A):

Since upon receipt of the following MAC frame transmitted from a user network #200-1 after the preparation described above, from port#2, edge node A receives a frame from the port of the line accommodation unit, edge node A relays the frame in the following forwarding plane using both an L2 forwarding unit 7 and a label addition unit 9.

Transmission destination MAC:00:aa:bb:00:00:01

Transmission source MAC:00:bb:aa:00:00:02

It is assumed that at this point, the route to the transmission destination MAC is not yet registered in an L2 route table 6.

L2 Forwarding Unit (Edge Node A):

The process of the L2 forwarding unit 7 of edge node A is described below.

Identification of VPN Corresponding to Receiving Port

The unit 7 obtains VPN#200 as the identifier of a VPN corresponding to a receiving port#2 using the VPN definition table 3.

Route learning check about transmission source MAC

The unit 7 retrieves data from an L2 route table 6 for VPN#200 using the transmission source MAC of a frame as a key.

If the retrieval hits, the unit 7 proceeds to a subsequent process without any other operation. In this case, since a route for an MAC address 00:bb:aa:00:00:02 has not been registered in the L2 route table 6, the retrieval mishits. Therefore, the unit 7 notifies the route registration unit 32 of the route non-registration. Then, the route registration unit 32 performs the following processes and registers the route for the transmission source MAC in all the L2 route tables 6 in the VPN.

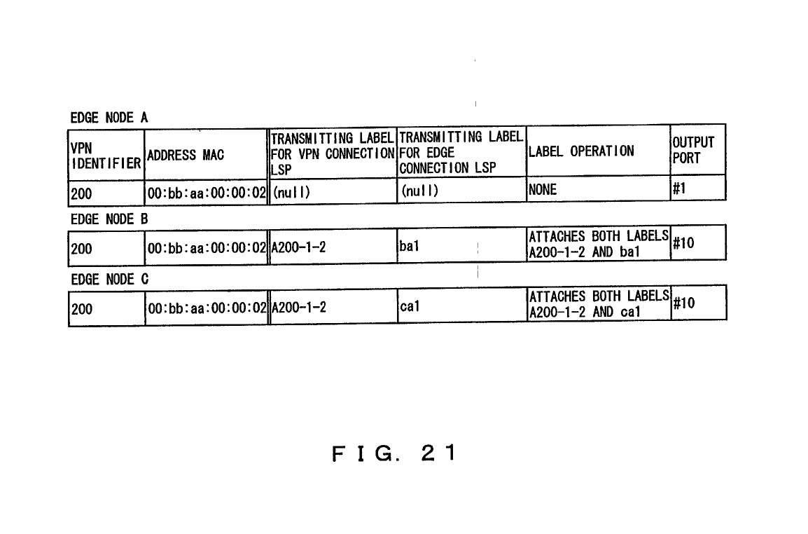

i) The unit 7 registers a pair of a transmission source MAC and a receiving port in an L2 route table 6 for VPN#200 (FIG. 21).

ii)The unit 7 obtains the layer 3 addresses (B, C) of an edge node with a port belonging to VPN#200 from the VPN management table 5 (FIG. 18).

iii) The unit 7 notifies nodes B and C of the following combination as a new route in the VPN.

{VPN#200, the Transmission Source MAC, port#2, Layer 3 Address (A)}

Upon receipt of the notice by edge node B and C, each of edge nodes B and C obtains both the notified layer 3 address A and a VPN connection LSP4 transmitting label corresponding to port#2 from the VPN management table 5 (FIG. 18), and obtains an edge connection LSP transmitting label for address A and an output port from the edge node management table 2 (FIG. 13). Then, each edge node registers the data in the L2 route table 6 for VPN#200 (FIG. 21). If the address of a specific entry is an LSP, the label operation field shown in FIG. 21 designates label addition. In this case, when being viewed from node A side, nodes B and C are located across an MPLS network. Therefore, label addition is designated.

Although each L2 route table logically relates a transmission destination MAC to an output destination separately for each VPN, as shown in FIG. 21, a plurality of L2 route tables can also be physically combined into one table by also including a VPN identifier in a table retrieval key.

Address Retrieval

The unit 7 retrieves data from an L2 rote table 6 for VPN#200 using the transmission destination MAC of a frame as a key. If the retrieval hits, the unit 7 obtains an output destination local port or information about an edge connection LSP and VPN connection LSP4. In this case, a route for an MAC address 00:aa:bb:00:00:01 has not been yet registered in the L2 route table 6 and the retrieval mishits. Therefore, the unit 7 transfers the frame to the intra-VPN broadcasting unit 12.

The intra-VPN broadcasting unit 12 broadcasts the frame to all the ports in the VPN. Although in this preferred embodiment, an arbitrary broadcasting unit can be used, in this example an entrance node copies a frame and transmits the frame to all the ports in the VPN.

Specifically, the intra-VPN broadcasting unit 12 refers to the VPN management table 5 (FIG. 18) and obtains both a list of local port numbers belonging to VPN#200 and a list of a plurality of pieces of information about VPN connections LSPs for ports in another node. In this case, the unit 12 obtains the followings.

1) List of local ports (#2): port#2

2) List of VPN connections LSPs

VPN connection LSP4 for port#1 of edge node B=transmitting label (B200-2-1)

VPN connection LSP4 for port#2 of edge node B=transmitting label (B200-2-2)

VPN connection LSP4 for port#2 of edge node C=transmitting label (B200-3-2)

The unit 12 further refers to the edge node management table 2 (FIG. 13) and obtains a list of a plurality of pieces of edge connections LSP1 transmission information about each edge node accommodating the broadcasting destination.

Edge connection LSP1 for edge node B (transmitting label (ab1)=output port=(#10))

Edge connection LSP1 for edge node C (transmitting label (ac1)=output port=(#10))

The intra-VPN broadcasting unit 12 further reproduces and transmits the frame to three output destinations, excluding receiving port #2, of all the obtained output destinations in VPN#200.

Output of Frame (Edge Node A)

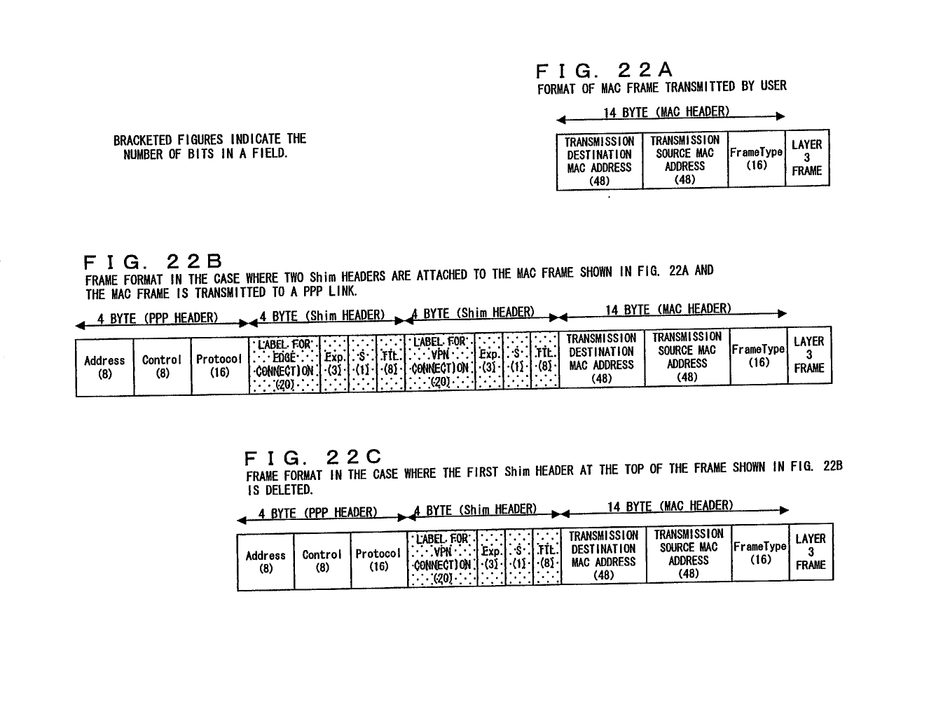

The intra-VPN broadcasting unit 12 transmits the frame to all the obtained output destinations. In this case, if the output destination is a local port, the unit 12 transmits the frame without performing any other process. If the output destination is an LSP, the label addition unit 9 attaches a label to the top of the frame and transmits the frame. FIGS. 22A and 22B show an MAC frame by transmitted by a user and the frame format after label addition, respectively. The Shim header shown in FIG. 22B is a header attached before a layer 3 header when using an existing MPLS in a PPP link. In this example, a label is stacked and attached before the MAC header shown in FIG. 22A of each frame copied by the intra-VPN broadcasting unit 12 as follows.

Label in the first Shim header:Transmitting label for edge connection LSP1

Label in the second Shim header:Transmitting label for VPN connection LSP4

Labels attached to each frame as a result are shown below (in the order of the second Shim and the first Shim from the top)

Frame for port#1 of edge node B:(ab1) and (B200-2-1)

Frame for port#2 of edge node B:(ab1) and (B200-2-2)

Frame for port#2 of edge node C:(ab2) and (C200-2-2)

In each field of Exp, S and TTL of a Shim header, a proper value is designated as in the existing MPLS.

MPLS Frame Relay Process in MPLS Relay Node:

The relay process in an MPLS network of a frame transmitted to the port#1 of edge node B is described below.

Relay of Frame with Label (Nodes ab1 and ab2)

As in the existing MPLS relay process, an MPLS relay node ab1 on the way between edge nodes refers to the label table 10 (FIG. 15) of the node using the label forwarding unit 11, as a result, replaces a label in the first Shim header with (ab2) and transmits the frame from port#1 to node ab2.

Similarly, an MPLS relay node ab2 on the way between edge nodes refers to the label table 10 (FIG. 15) of the node using the label forwarding unit 11, as a result, deletes the first Shim header (Shim header, including a label value ab2) and transmits the frame from port#1 to node B.

FIG. 22C shows a frame format after the deletion of the first Shim header.

MPLS Frame Relay Process in Exit Node (Edge Node B):

Frame relay in exit node B is described below.

Label Forwarding Unit (Edge Node B)

Upon receipt of a frame from the port of an MPLS network accommodation unit, edge node B refers to the label table 10 (FIG. 19), as a result, deletes the first Shim header (Shim header, including a label value B200-2-1) and transmits the frame from port#1.

By applying the processes described above to all the copied frames as broadcasting destinations in VPN#200, frame broadcasting within VPN#200 can be implemented.

Next, a relay process in the case where edge node B receives a MAC frame transmitted from a user network #200-2-1, from port#2 in response to the frame transmitted from user network #200-1, which is described above, is described.

Address of this MAC Frame:

Transmission destination MAC:00:bb:aa:00:00:02

Transmission source MAC:00:aa:bb:00:00:01

MPLS Frame Relay Process in Entrance Node (Edge Node B)

Upon receipt of a frame from the port of a line accommodation unit, edge node B relays the frame in a forwarding plane as follows using both the L2 forwarding unit 7 and label addition unit 9.

L2 Forwarding Unit (Edge Node B)

Identification of VPN Corresponding to Receiving Port

The L2 forwarding unit obtains VPN#200 as the identifier of a VPN corresponding to receiving port#1 using the VPN definition table 3.

Route Learning Check about Transmission Source MAC

The unit retrieves data from an L2 route table 6 for VPN#200 using the transmission source MAC of the frame as a key.

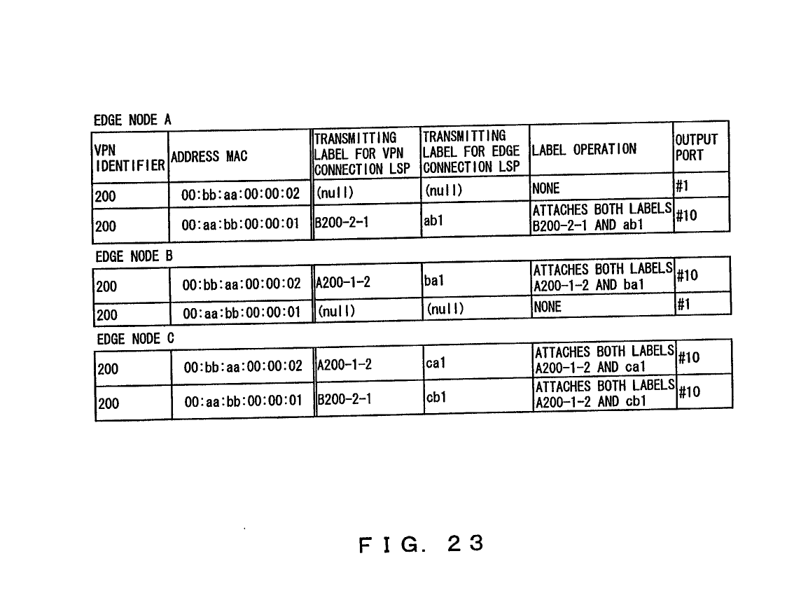

If the retrieval hits, the unit proceeds to a subsequent process without any other operation. However, in this case, since a route for MAC address 00:aa:bb:00:00:01 has not been yet registered in the L2 route table 6 and thereby the retrieval mishits, as in the route learning check about transmission source MAC of the forwarding unit of edge node A, the route registration unit 32 a route for the transmission source MAC in all the route tables 6 in the VPN. FIG. 23 shows the registration result.

Address Retrieval

The unit retrieves data from the L2 route table 6 for VPN#200 using the transmission destination MAC of the frame as a key. If the retrieval hits, the unit obtains the local port of an output destination or information about edge connection LSP and VPN connection LSP4. If the retrieval mishits, the unit transfers the frame to the intra-VPN broadcasting unit 12.

In this case, since an MAC address 00:bb:aa:00:00:02 is already registered in the L2 route table 6 (FIG. 23), the retrieval hits. Therefore, the unit obtains both information about the edge connection LSP of an output destination (label value ba1 and output port #10) and information about VPN connection LSP4 (label value A200-1-2).

Output of Frame (Edge Node B)

The unit transmits the frame to the obtained output destination. In this case, if the output destination is a local port, the unit transmits the frame without performing any other process. If the output destination is an LSP, the label addition unit 9 attaches a label to the top of the frame and transmits the frame. In this example, since the output destination is an LSP, the unit attaches a Shim header before a layer 3 header in the order of label values ba1 and A200-1-2 from the top, as in the operation of the forwarding unit.

MPLS Frame Relay Process in MPLS Relay Node:

Relay of Frame with Label (Nodes ba1 and ba2)

As in the frame relay with a label of an MPLS frame relay process in an MPLS relay node, MPLS relay nodes ba1 and ba2 on the way between edge nodes deletes the first Shim header by the existing MPLS relay process and transmits the frame node A.

MPLS Frame Relay Process in Exit Node (Edge Node A):

Label Forwarding Unit (Edge Node A)

Upon receipt of the frame from the port of an MPLS network accommodation unit, edge node B refers to the label table 10 (FIG. 19) using the label forwarding unit 11, as a result, deletes the first Shim header (Shim header, including label value A200-1-2), and transmits the frame from port#2.

As described above, the device of the present invention can perform address learning by a transmission source MAC, route determination by a transmission destination MAC and broadcasting within the VPN at the time of transmission destination MAC non-learning, and a layer 2-VPN can be organized.

Since the forwarding plane process is a simple process for referring to a table using the parameter with a fixed length of the frame and performing both direction determination and header addition/deletion, the speed of the process can be easily improved.

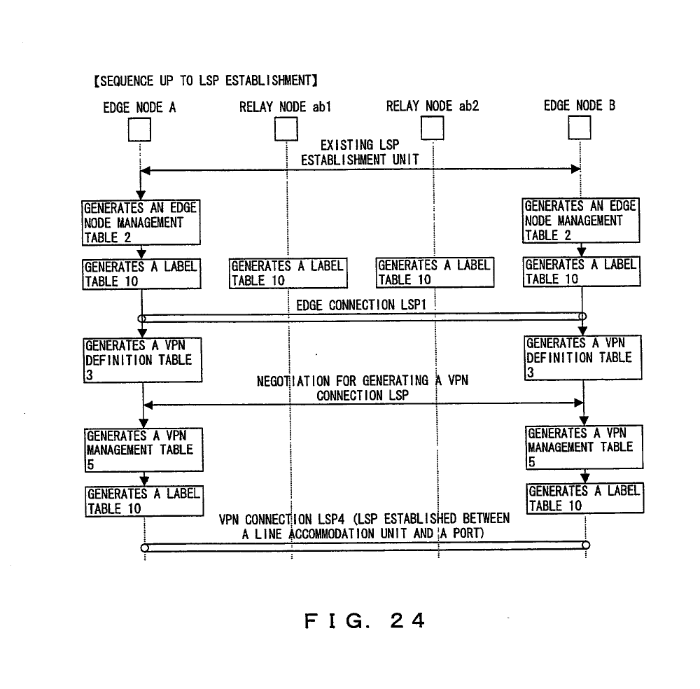

FIG. 24 is a sequence chart showing a process up to the LSP establishment in the specific example of the first preferred embodiment.

First, it is assumed that relay nodes ab1 and ab2 are installed between edge nodes A and B. Each of edge nodes A and B starts an existing LSP establishment unit. Then, each of nodes A and B generates an edge node management table 2. Then, each of edge nodes A/B and relay nodes ab1/ab2 generates a label table 10. In this way, an edge connection LSP1 is established between edge nodes A and B.

Then, each of edge nodes A and B generates a VPN definition table 3 and make negotiation to establish a VPN connection LSP. After the negotiation, each node generates a VPN management table 5. Then, each of edge nodes A and B generates a label table 10 and establishes a VPN connection LSP4. This VPN connection LSP4 connects the line accommodation unit of an originating edge node to the port of a terminating edge node in the first preferred embodiment.

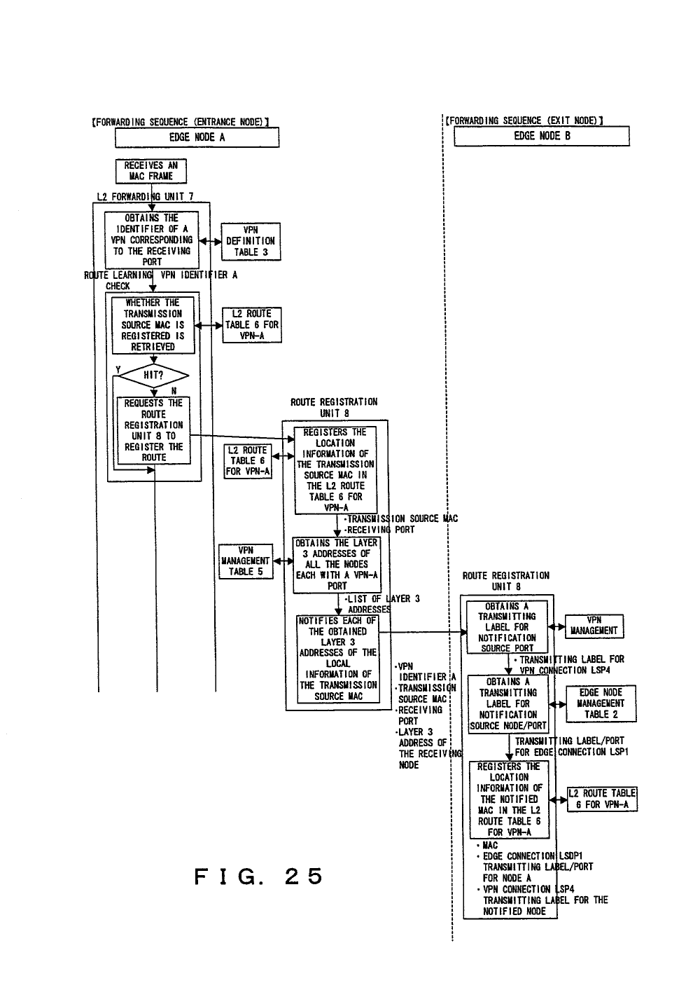

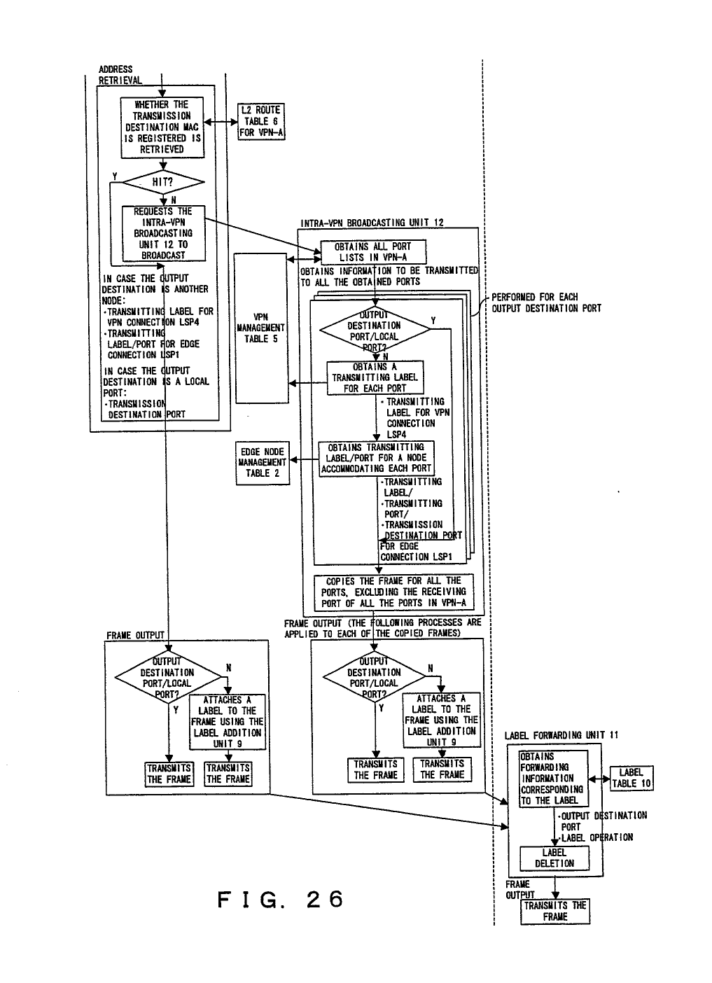

FIGS. 25 and 26 are sequence charts showing frame forwarding.

First, upon receipt of an MAC frame, edge node A, which is an entrance node, obtains the identifier of a VPN corresponding to the receiving port from the VPN definition table 3 using the L2 forwarding unit 7. Here, the VPN identifier is assumed to be A. Then, route learning is checked. Specifically, an L2 route table 6 for VPN-A is referenced and it is retrieved whether the transmission source MAC is registered. If the retrieval mishits, a route registration request is issued to the route registration unit 8 and the address is retrieved. If the retrieval hits, the address is simply retrieved.

In the route registration request, the route registration unit 8 registers the location information of the transmission source MAC in the L2 route table 6 for VPN-A by referring to the L2 route table 6 for VPN-A. In this case, both the transmission source MAC and receiving port are registered. Then, the VPN management table 5 is referenced and the layer 3 addresses of all the nodes with a port VPN-A. At this time, a list of layer 3 addresses is generated. Then, the location information of the transmission source MAC is notified to each of the obtained layer 3 addresses. The content of this notice includes the VPN identifier A, the transmission source MAC, the receiving port and the layer 3 address of the receiving node. In response to the notice from edge node A, edge node B, which is an exit node, obtains a transmitting label for notification destination port by referring to the VPN management table 5 using the route registration unit 8. Specifically, a transmitting label for a VPN connection LSP4 is obtained. Then, transmitting label for notification source node/port are obtained by referring to the edge node management table 2. Specifically, both a transmitting label for an edge connection LSP1 and a transmitting port are obtained. Then, the notified location information of the MAC is registered in the L2 route table 6 for VPN-A. Specifically, an MAC, an edge connection LSP1 transmitting label for node A, a transmitting port and a VPN connection LSP4 transmitting label for a notified port are registered.

If in the route learning check, the L2 route table 6 for VPN-A is retrieved and a transmission source MAC is obtained, the L2 forwarding unit 7 performs address retrieval without issuing the registration request.

In the address retrieval, the L2 route table 6 for VPN-A is referenced and it is retrieved whether the transmission source MAC is already registered. If the retrieval hits, a transmitting label for a VPN connection LSP4, a transmitting label for an edge connection LSP1 and a transmitting port are obtained if the output destination is another node. If the output destination is a local port, a transmission destination port is obtained. Then, in frame output it is judged whether the output port is a local port. If the output port is a local port, the frame is transmitted without performing any other process. If the output port-is not a local port, the label addition unit 9 attaches a label the frame and transmits the frame.

If in the address retrieval it is judged that the transmission source MAC has not been yet registered (the retrieval mishits), a broadcasting request is issued to the intra-VPN broadcasting unit 12. Upon receipt of the broadcasting request, the intra-VPN broadcasting unit 12 obtains all the port lists in VPN-A by referring to the VPN management table 5 and obtains transmission information about each of the obtained ports. Specifically, the unit 12 judges whether the output destination port is a local port. If the output destination port is a local port, the unit 12 obtains an output destination port. If the output destination port is not a local port, the unit 12 obtains a VPN connection LSP4 transmitting label for each port from the VPN management table 5 and further obtains edge connection LSP transmitting label/port for a node accommodating each port by referring to the edge node management table 2. This obtained information includes a transmitting label for an edge connection LSP1, a transmitting port and a transmission destination port. After obtaining transmission information about all the ports, the unit 12 copies the frame for all the ports, excluding a receiving port, in VPN-A. Then, the flow proceeds to frame output.

In frame output, if the output port is a local port, the frame is transmitted without performing any other process. If the output port is not a local port, the label addition unit 9 attaches a label to the frame and transmits the frame.

Upon receipt of the frame with a label, the label forwarding unit 11 of an exit node obtains information for forwarding corresponding to the label from the label table 10. Specifically, the unit 11 obtains an output destination port and performs a label operation. Then, the unit 11 deletes the label and transmits the frame.

A specific example of the second preferred embodiment is described below.

The specific example of this preferred embodiment presumes the establishment of the same VPN as that shown in FIG. 12.

VPN Definition of and LSP Establishment (Preparation for Frame Relay):

First, the flows of both LSP establishment and VPN definition made before frame relay between user networks in the layer 2-VPN system of this preferred embodiment are described.

Establishment of Edge Connection LSP

Generation of Edge Node Management Table

An existing LSP establishment unit, such as LDP and the like establishes an edge connection LSP1 for inter-connecting edge nodes between edge nodes A, B and C, and registers the established LSPs in the edge node management table 2 of a control plane.

In the edge node management table 2, both a label and output port that are attached to a frame when transmitting the frame to the LSP are stored. Although a node in an MPLS network (node other than an edge node) also generates such a table, in FIG. 13, nodes other than an edge node are omitted.

Generation of Label Table

Each of nodes in each MPLS network (edge nodes and each node in an MPLS network) generates the label table 10 of a forwarding plane using the generated LSP.

VPN definition and establishment of VPN connection LSP

Generation of VPN Definition Table

A belonging VPN is related to each port in the edge node, based on both the user network and VPN definition shown in FIG. 12.

Establishment of VPN Connection LSP

Each edge node obtains information about the correspondence between a port accommodated by another edge node and the VPN by prescribed negotiation and establishes a bi-directional LSP (VPN connection LSP4) between the node and all the ports in another node belonging to the same VPN as that accommodated by a local node.

As in the first preferred embodiment, an arbitrary unit can conduct the negotiation and establish a VPN connection LSP20. The established VPN connection LSP4 is registered in the VPN management table 5 and simultaneously information about both the backward VPN connection LSP4 of the VPN connection LSP4 and an edge connection LSP1, specifically, a transmitting label for the backward VPN connection LSP4, a transmitting label for an edge connection LSP1 and an output port, for each receiving label, are registered in the LSP backward conversion table 25.

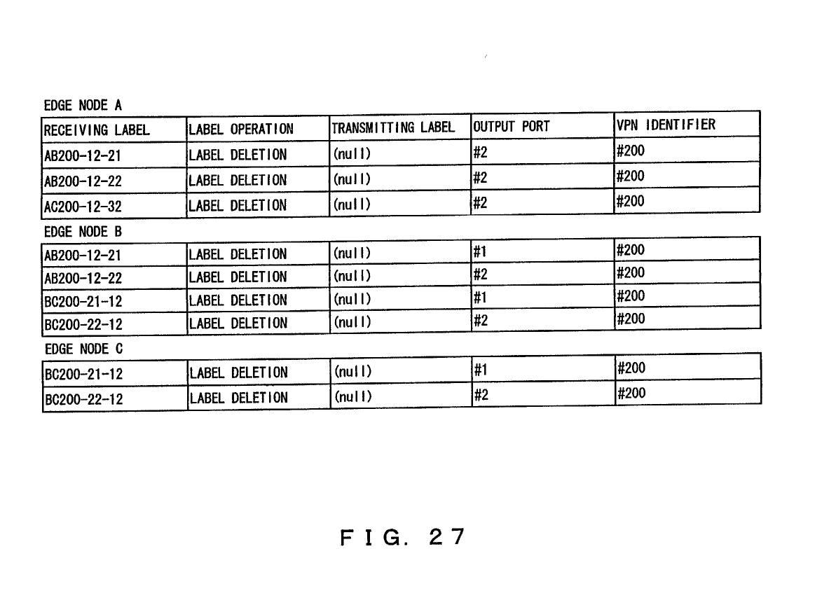

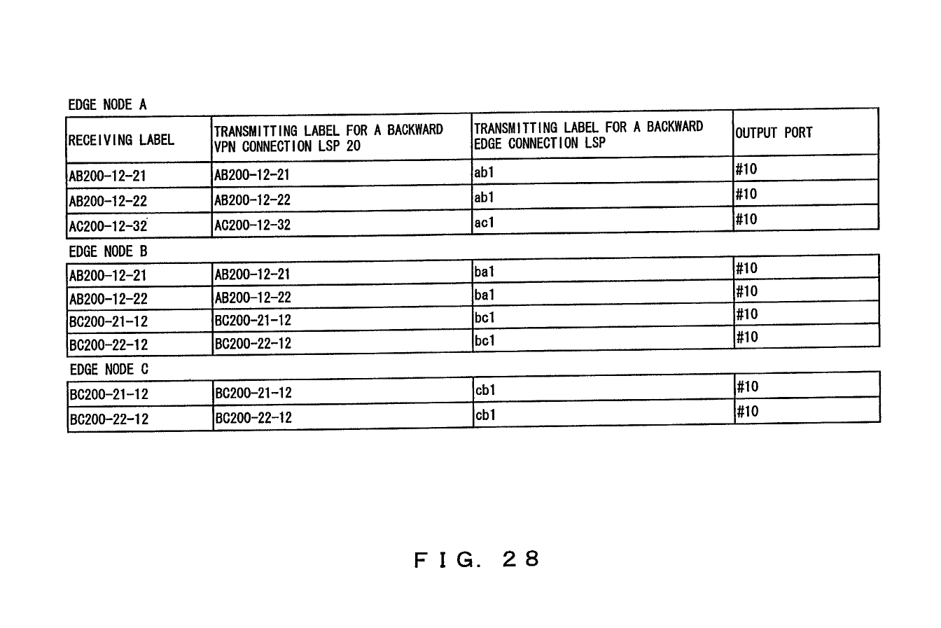

FIGS. 27 and 28 show a label table 10 generated on a forwarding plane when establishing a VPN connection LSP4, and an LSP backward conversion table 25 generated on a control plane, respectively.

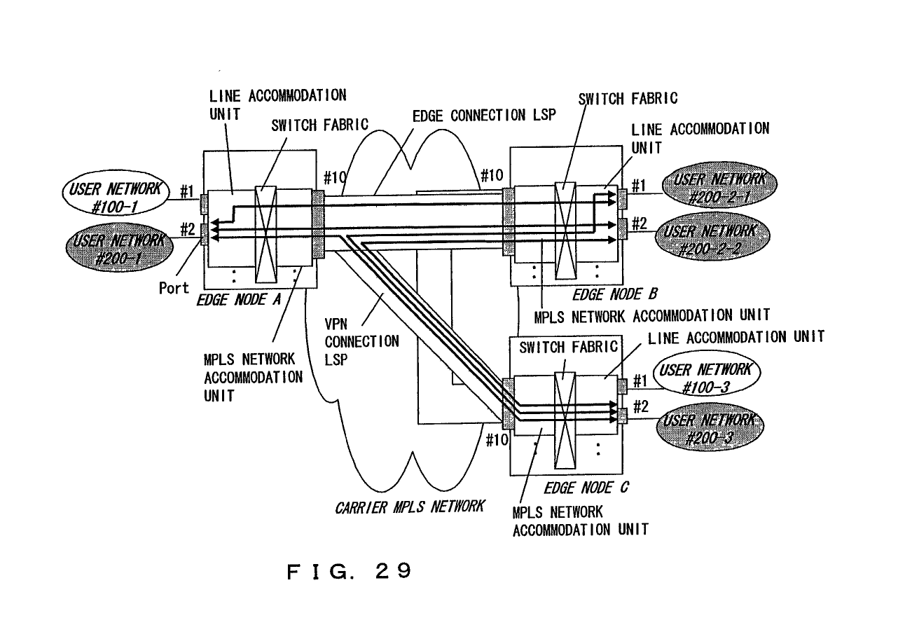

FIG. 29 shows both the edge connection LSP1 and VPN connection LSDP4 established by the processes described so far to organize the VPN shown in FIG. 12.

In FIG. 29, only LSPs used to organize VPN#200 are shown and LSPs used to organize VPN#100 are omitted.

MAC Frame Relay Process in Entrance Node (Edge Node A):

Upon receipt of the following MAC frame transmitted from a user network #200-1 after the preparation described above, from port#2, edge node A relays the frame in a forwarding plane as follows using both an L2 forwarding unit 55 and the label addition unit 9 since edge node A has received a frame from a port in a line accommodation unit.

Transmission destination MAC:00:aa:bb:00:00:01

Transmission source MAC:00:bb:aa:00:00:02

It is assumed that at this moment, a route for the transmission destination MAC has not been yet registered in an L2 route table 21.

L2 Forwarding Unit (Edge Node A)

The process of the L2 forwarding unit 55 of edge node A is described below.

Identification of VPN Corresponding to Receiving Port

The L2 forwarding unit 55 obtains VPN#200 from the VPN definition table 3 as the identifier of a VPN corresponding to receiving port#2.

Route Learning Check about Transmission Source MAC

The unit 55 retrieves data from an L2 route table 21 for receiving port#2 using the transmission source MAC as a key.

If the retrieval hits, the flow proceeds to a subsequent address retrieval without performing any other process. However, in this case, a route for an MAC address 00:bb:aa:00:00:02 has not been yet registered in the L2 route table 21 and thereby the retrieval mishits. Therefore, edge node A notifies an entrance route registration unit 23 of the route non-registration. The entrance route registration unit 23 performs the following processes and registers the route for the transmission source MAC in the L2 route table 21 for receiving port.

The unit 55 registers a pair of the transmission source MAC and receiving port in an L2 route table 21 for a receiving port#2.

Address Retrieval

The unit 55 retrieves data from an L2 route table 21 for port#2 using the transmission destination MAC of the frame as a key.

If the retrieval hits, the unit 55 obtains the local port of an output destination or information about edge connection LSP and VPN connection LDP4. However, in this case, since a route for an MAC address 00:aa:bb:00:00:01 has not been yet registered in the L2 route table 21 and thereby the retrieval mishits. Therefore, the unit 55 transfers the frame to the intra-VPN broadcasting unit 12.

The intra-VPN broadcasting unit 12 broadcasts the frame to all the ports in the VPN. Although an arbitrary broadcasting unit can be used in this preferred embodiment, in this example, an entrance node copies the frame and transmits the frame to all the ports.

Specifically, the intra-VPN broadcasting unit 12 refers to the VPN management table 5 and obtains both a local port number belonging to VPN#200 and information about ports in another node.

i) List of local ports (#2): port#2

ii)List of VPN connections LSPs

VPN connection LSP20 for port #1 of edge node B

VPN connection LSP20 for port #2 of edge node B

VPN connection LSP20 for port #2 of edge node C

The unit 12 further refers to the edge node management table 2 and obtains a list of a plurality of pieces of information about edge connection LSP1 transmission information about each edge node accommodating the broadcasting destination port.

Edge Connection LSP1 Transmitting Label (ab1) for Edge Node B and Output Port (#10)

Edge Connection LSP1 Transmitting Label (ac1) for Edge Node C and Output Port (#10)

Furthermore, the intra-VPN broadcasting unit 12 copies and transmits the frame to three output destinations, excluding receiving port #2, of all the obtained output destinations in the VPN#200.

Frame Output (Edge Node A)

The unit 12 transmits the frame to all the obtained output destinations. In this case, if the output destination is a local port, the frame is transmitted without performing any other process. If the output destination is an LSP, the label addition unit 9 attaches a label to the top of the frame and transmits the frame.

MPLS Frame Rely Process in MPLS Relay Node:

The relay process in an MPLS network of a frame transmitted to the port#1 of edge node B is described below.

Relay of Frame with Label (Nodes ab1 and ab2)

As in the existing MPLS relay process, an MPLS relay node ab1 on the way between edge nodes refers to the label table 10 of the node using the label forwarding unit 11, as a result, replaces a label in the first Shim header with (ab2) and transmits the frame from port#1 to node ab2.

Similarly, an MPLS relay node ab2 on the way between edge nodes refers to the label table 10 of the node using the label forwarding unit 11, as a result deletes the first Shim header (Shim header, including a label value ab2) and transmits the frame from port#1 to node B.

MPLS Frame Relay Process in Exit Node (Edge Node B):

Frame relay in exit node B is described below.

Label Forwarding Unit (Edge Node B)

Upon receipt of a frame from the port of an MPLS network accommodation unit, edge node B refers to the label table 10 using the label forwarding unit 11, as a result, deletes the first Shim header and also obtains a corresponding output port.

Route Registration Confirmation Unit (Edge Node B)

The route registration confirmation unit 26 retrieves data from an L2 route table 21 for an output port obtained by the label forwarding unit (edge node B). If the retrieval mishits, the unit 26 notifies the exit route registration unit 27 of the route non-registration. Since in this case, the retrieval mishits, when being notified of the route non-registration, the exit route registration unit 27 calculates both the backward VPN connection LSP4 of the received VPN connection LSP4 and an edge connection LSP1 from the LSP backward conversion table 25, registers the connections in the L2 route table 2 for the port and transmits the frame from port#1.

By applying the processes described above to all the copied frames as broadcasting destinations in VPN#200, frame broadcasting in VPN#200 can be implemented.

Next, a relay process in the case where edge node B receives an MAC frame transmitted from a user network #200-2-1, from port#1 in response to the frame transmitted from user network #200-1 is described.

Address of this MAC Frame:

Transmission destination MAC:00:bb:aa:00:00:02

Transmission source MAC:00:aa:bb:00:00:01

MPLS Frame Relay Process in Entrance Node (Edge Node B)

Upon receipt of a frame from the port of a line accommodation unit, edge node B relays the frame in a forwarding plane as follows using both the L2 forwarding unit 55 and label addition unit 9.

L2 forwarding unit (edge node B)

Identification of VPN Corresponding to Receiving Port

The unit obtains VPN#200 as the identifier of a VPN corresponding to receiving port#1 from the VPN definition table 3.

Route Learning Check about Transmission Source MAC

The unit retrieves data from an L2 route table 21 for VPN#200 using the transmission source MAC of the frame as a key.

If the retrieval hits, the unit proceeds to a subsequent process without any other operation. However, in this case, since a route for MAC address 00:aa:bb:00:00:01 has not been yet registered in the L2 route table 21 and thereby the retrieval mishits. Therefore, as in the route learning check about transmission source MAC, the route registration unit 8 registers the route for the transmission source MAC in the L2 route tables 21 for each port belonging to the VPN.

Address Retrieval

The unit retrieves data from the L2 route table 21 for VPN#200 using the transmission destination MAC of the frame as a key.

If the retrieval hits, the unit obtains the local port of an output destination or information about edge connection LSP/VPN connection LSP4. If the retrieval mishits, the unit transfers the frame to the intra-VPN broadcasting unit 12.

In this case, since an MAC address 00:bb:aa:00:00:02 is already registered in an L2 route table 21, the retrieval hits. Therefore, the unit obtains both information about the edge connection LSP of an output destination (label value ba1 and output port #10) and information about VPN connection LSP4.

Output of Frame (Edge Node B)

The unit transmits the frame to the obtained output destination. In this case, if the output destination is a local port, the unit transmits the frame without performing any other process. If the output destination is an LSP, the label addition unit 9 attaches a label to the head of the frame and transmits the frame. In this example, since the output destination is an LSP, the unit attaches a Shim header before a layer 3 header.

MPLS Frame Relay Process in MPLS Relay Node:

Relay of Frame with Label (Nodes ba1 and ba2)

As in the frame relay with a label (nodes ab1 and ab2), each of MPLS relay nodes ba1 and ba2 on the way between edge nodes deletes the first Shim header by the existing MPLS relay process and transmits the frame node B.

MPLS Frame Relay Process in Exit Node (Edge Node A):

Label Forwarding Unit (Edge Node A)

Upon receipt of the frame from the port of an MPLS network accommodation unit, edge node B refers to the label table 10 using the label forwarding unit 11, as a result, deletes the first Shim header and also obtains a corresponding output port.

Route Registration Confirmation Unit (Edge Node B)

The route registration confirmation unit 26 retrieves data from the L2 route table 21 for an output port obtained the label forwarding unit (edge node A) using the transmission source MAC of the frame as a key. If the retrieval mishits, the unit 26 notifies the exit route registration unit 27 of the route non-registration. In this case, since the retrieval hits, the unit 26 transmits the frame from port #2 without performing any other process.

As described above, the system of the present invention can perform address learning by a transmission source MAC, route determination by a transmission destination MAC and broadcasting within the VPN at the time of transmission destination MAC non-learning, and thereby a layer 2-VPN can be organized.

Since the forwarding plane process is a simple process for referring to a table using the parameter with a fixed length of the frame and performing both direction determination and header addition/deletion, the speed of the process can be easily improved.

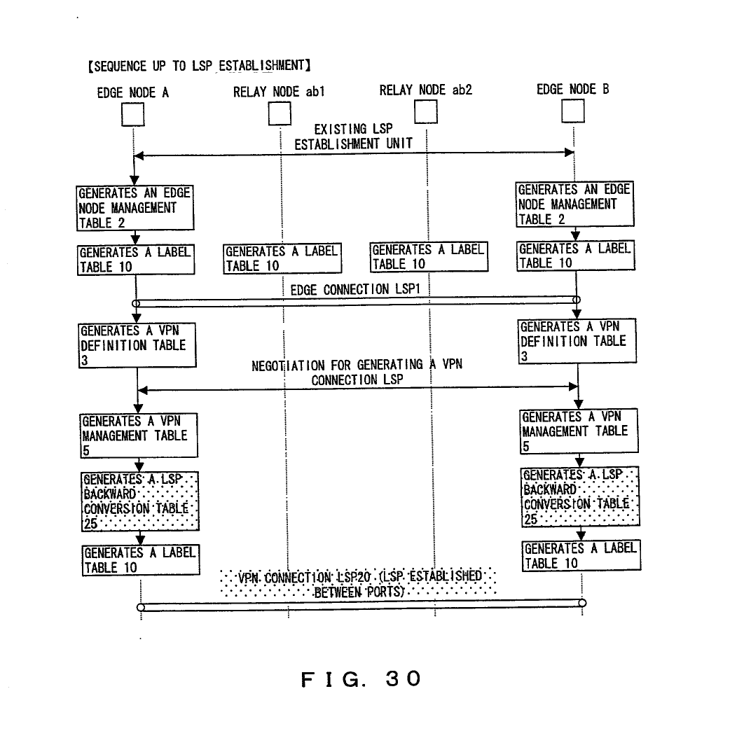

FIG. 30 is a sequence chart showing a process up to the establishment of an LSP in a specific example of the second preferred embodiment.

In this example it is assumed that relay nodes ab1 and ab2 are installed between edge nodes A and B. First, each of edge nodes A and B starts an existing LSP establishment unit. Then, each of nodes A and B generates an edge node management table 2. Then, each of edge nodes A/B and relay nodes ab1/ab2 generates a label table 10. In this way, an edge connection LSP1 is established between edge nodes A and B.

Then, each of edge nodes A and B generates a VPN definition table 3 and edge nodes A and B negotiate to establish a VPN connection LSP. Then, each of edge nodes A and B generates a VPN management table 5. Then, each of edge nodes A and B generates an LSP backward conversion table 25. By each node generating a label table 10, a VPN connection LSP20 is established. Specifically, a connection is established between the port of the entrance node of an edge node and the port of the exit node.

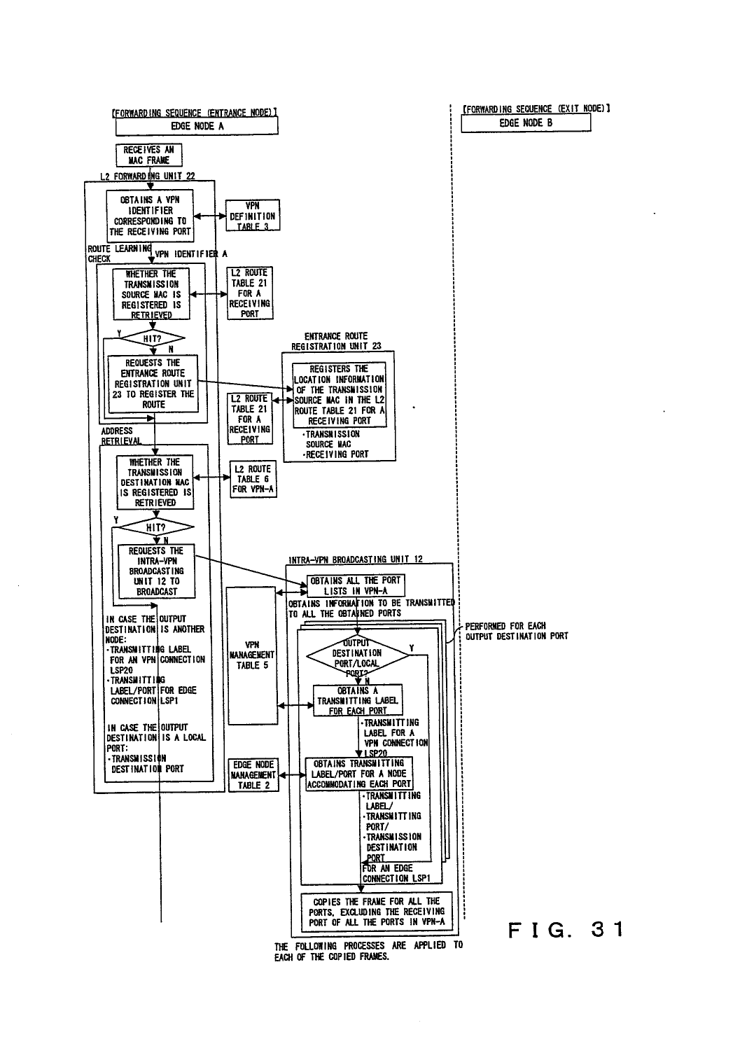

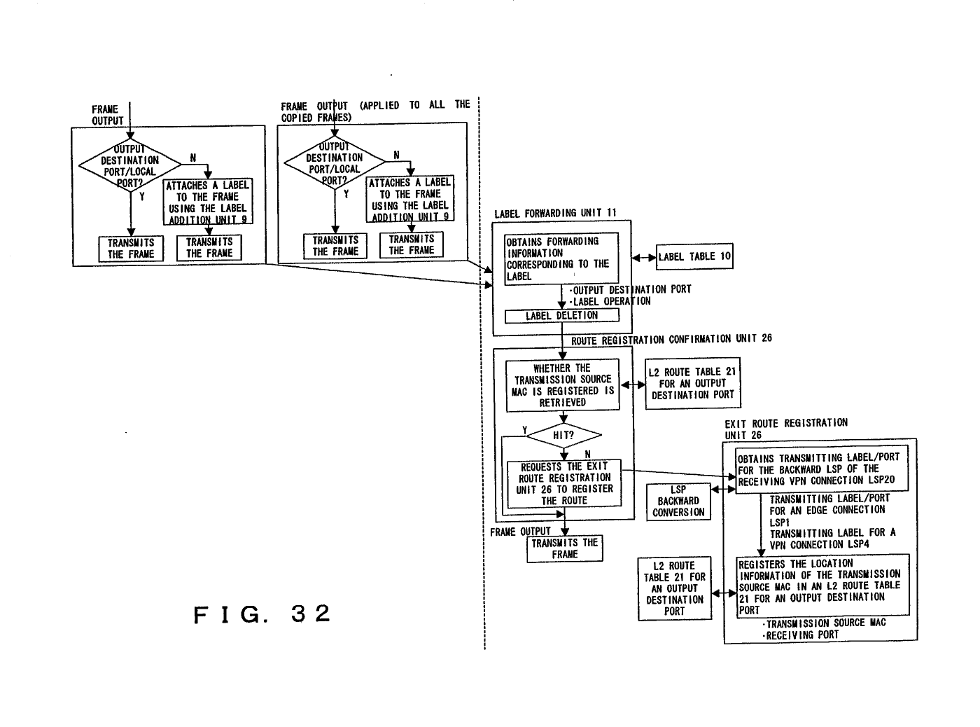

FIGS. 31 and 32 are sequence charts showing frame forwarding.

First, when edge node A, which is an entrance node, receives an MAC frame, an L2 forwarding unit 22 starts to obtain the identifier of a VPN corresponding to the receiving port by referring to the VPN definition table 3. In this example, the VPN identifier is assumed to be A.

Then, in route learning check, it is retrieved whether the transmission source MAC is already registered by referring to an L2 route table 2 for a receiving port. If the retrieval hits, the flow proceeds to address retrieval. If the retrieval mishits, a route registration request is issued to the entrance route registration unit 23 and then the flow proceeds to address retrieval.

The entrance route registration unit 23 registers the location information of the transmission source MAC in the L2 route table 21 for a receiving port. Specifically, the unit 23 registers both the transmission source MAC and receiving port.

In address retrieval, it is retrieved whether the transmission source MAC is already registered by referring to the L2 route table 21 for a receiving port. If the retrieval hits, the flow proceeds to frame output. In this case, if the output destination is another node, a transmitting label for a VPN connection LSP20, a transmitting label for an edge connection LSP1 and a transmitting port are transmitted to a frame output. If the output destination is a local port, a transmitting port is transmitted to a frame output.

If in the retrieval of whether the transmission source MAC is already registered, it is judged that the retrieval mishits, a broadcasting request is issued to the intra-VPN broadcasting unit 12. The intra-VPN broadcasting unit 12 obtains all the port lists in VPN-A from the VPN management table 5 and obtains a plurality of pieces of transmission information about all the obtained ports. Specifically, it is judged whether the output destination port of each output port is a local port. If the output destination port is a local port, an transmission destination port is obtained as transmission information. If the output destination port is not a local port, a VPN connection LSP20 transmitting label for the port is obtained from the VPN management table 5 and transmitting labels for a node accommodating each port/port are further obtained by referring to the edge node management table 2. This obtained information includes a transmitting label for an edge connection LSP1, a transmitting port and a transmission destination port. Then, after obtaining transmission information about all the ports, the frame is copied for all the ports in VPN-A. Then, the flow proceeds to frame output.

If in address retrieval, it is judged that the transmission destination MAC is registered, in frame output, it is judged whether the output destination port is a local port. If the output destination port is a local port, the frame is transmitted. If the output destination port is not a local port, the label addition unit attaches a label to the frame and the frame is transmitted. If the frame is broadcast too, in frame output, it is judged whether the output destination port is a local port. If the output destination port is a local port, the frame is transmitted. If the output destination port is a local port, the label addition unit attaches a label to the frame and the frame is transmitted.

Upon receipt of the frame, an exit node obtains information for forwarding corresponding to the label of the received frame from the label table 10 using the label forwarding unit 11. In this case, an output destination port is obtained and a label operation is performed. Then, a label for transferring between ports is deleted and the route registration confirmation unit 26 retrieves whether the transmission source MAC is registered from the L2 route table 21 for an output destination port. If the retrieval hits, the frame is outputted. If the retrieval mishits, a route registration request is issued to the exit route registration unit 27.

The exit route registration unit 27 obtains transmitting label/port for the backward LSP of a received VPN connection LSP20 by referring to the LSP backward conversion table 25. In this case, a transmitting label for an edge connection LSP1, a transmitting port, a transmitting label for a VPN connection LSP20 and the like are obtained. Then, the location information of the transmission source MAC is registered in the L2 route table 21 for an output destination port. Specifically, both the transmission source MAC and receiving port are registered. In this case, the route registration unit 26 refers to the L2 route table 21 for an output destination port.

A specific example of the third preferred embodiment is described below.

The specific example of this preferred embodiment presumes the same VPN establishment as shown in FIG. 12.

VPN Definition and LSP Establishment (Preparation for Frame Relay)

First, the flows of both the of LSP establishment and VPN definition that are made in preparation to relay a frame between user networks in the layer 2-VPN system of the present invention are described.

Establishment of Edge Connection LSP

Generation of Edge Node Management Table

An existing LSP generation unit, such as an LDP and the like establishes in advance an edge connection LSP1 for inter-connecting edge nodes, between edge nodes A, B and C, and registers the generated LSPs in the edge node management table 2 of a control plane.

In the table, both a label and an output port that are attached to a frame when transmitting the frame to the LSP are stored as LSP parameters. Although a node in an MPLS network (node other than edge nodes) also generates such a table, those for nodes other than edge nodes are omitted in FIG. 13.

Generation of Label Table

Each of nodes in each MPLS network (edge nodes and each node in an MPLS network) generates the label table 10 of a forwarding plane, based on the generated LSP.

VPN Definition and Establishment of VPN Connection LSP

Generation of VPN Definition Table

A belonging VPN is related to each port in an edge node, based on both the user network and VPN definition that are shown in FIG. 12.

Establishment of VPN Connection LSP

Each edge node obtains information about correspondence between ports accommodated by another edge node and a VPN by some negotiation and establishes a bi-directional LSP (VPN connection LSP20) between a VPN accommodated by a local node and all the ports in another node belonging to the VPN.

As in the first preferred embodiment, an arbitrary unit can conduct the negotiation and can establish the VPN connection LSP 20. Each edge node registers the established VPN connection LSP 20 in the VPN management table 5 and further registers information about both the backward VPN connection LSP 20 of the VPN connection LSP 20 and an edge connection LSP1, specifically, a transmitting label for a backward VPN connection LSP 20, a transmitting label for an edge connection LSP1 and an output port, in the LSP backward conversion table 25 for each receiving label.

FIGS. 27 and 28 show a label table 10 to be generated in a forwarding plane when generating a VPN connection 20 and an LSP backward conversion table 25 generated in a control plane, respectively.

FIG. 29 shows both an edge connection LSP1 and a VPN connection LSP20 established to organize the VPN shown in FIG. 12. In FIG. 29, only LSPs used to organize VPN#200 are shown and LSPs used to organize VPN#100 are omitted.

MAC Frame Relay Process in Entrance Node (Edge Node A)

Upon receipt of the following MAC frame transmitted from a user network #200-1 after the preparation described above, from port#2, edge node A relays the frame in a forwarding plane as follows using both an L2 forwarding unit 22 and the label addition unit 9 since edge node A has received a frame from a port in a line accommodation unit.

Transmission destination MAC:00:aa:bb:00:00:01

Transmission source MAC:00:bb:aa:00:00:02

It is assumed that at this moment, a route for the transmission destination MAC has not been yet registered in an L2 route table 21.

L2 Forwarding Unit (Edge Node A)

The process of the L2 forwarding unit 22 of edge node A is described below.

Identification of VPN Corresponding to Receiving Port

VPN#200 is obtained from the VPN definition table 3 as the identifier of a VPN corresponding to receiving port#2.

Route Learning Check about Transmission Source MAC

The L2 forwarding unit 22 retrieves data from an L2 route table 21 for receiving port#2 using the transmission source MAC as a key.

If the retrieval hits, the flow proceeds to a subsequent address retrieval without performing any other process. However, in this case, a route for an MAC address 00:bb:aa:00:00:02 has not been yet registered in the L2 route table 21 and the retrieval mishits. Therefore, the route non-registration is notified to the route registration unit 8. The route registration unit 8 performs the following processes and registers the route for the transmission source MAC in the L2 route table 21 for all the ports belonging to the VPN.

The unit 22 registers a pair of the transmission source MAC and receiving port in an L2 route table 21 for a receiving port.

The unit 22 obtains the layer 3 addresses (B and C) of an edge node with a port belonging to VPN#200 from the VPN management table 5.

The unit 22 notifies nodes B and C of the following combination as a new route in the VPN.

{VPN#200, the Transmission Source MAC, port#2 and Layer 3 Address (A)}

Upon receipt of the notice, each of edge nodes B and C obtains a transmitting label for a VPN connection LSP 20 corresponding to the notified port#2 from the VPN management table 5 (FIG. 18) and obtains both an edge connection LSP transmitting label for address A and an output port from the edge node management table 2 (FIG. 13). Each of edge nodes B and C registers the plurality of pieces of data in an L2 route table for all the ports belonging to VPN#200 (FIG. 21).

Address Retrieval

The unit 22 retrieves data from the L2 route table 21 for port#2 using the transmission destination MAC of the frame as a key.

If the retrieval hits, the unit 22 obtains the local port of an output destination or information about edge connection LSP/VPN connection LDP4. However, in this case, since a route for an MAC address 00:aa:bb:00:00:01 has not been yet registered in the L2 route table 21 and thereby the retrieval mishits. Therefore, the unit 22 transfers the frame to the intra-VPN broadcasting unit 12.

The intra-VPN broadcasting unit 12 broadcasts the frame to all the ports in the VPN. Although an arbitrary broadcasting unit can be used in this preferred embodiment, in this example, an entrance node copies the frame and transmits the frame to all the ports in the VPN.

Specifically, the intra-VPN broadcasting unit 12 refers to the VPN management table 5 and obtains both a local port number belonging to VPN#200 and information about ports in another node.

i) List of local ports (#2): port#2

ii)List of VPN connections LSPs

VPN connection LSP20 for port #1 of edge node B

VPN connection LSP20 for port #2 of edge node B

VPN connection LSP20 for port #2 of edge node C

The unit 12 further refers to the edge node management table 2 and obtains a list of a plurality of pieces of edge connection LSP1 transmission information about each edge node accommodating a broadcasting destination port.

Edge Connection LSP1 Transmitting Label (ab1) for Edge Node B and Output Port (#10)

Edge Connection LSP1 Transmitting Label (ac1) for Edge Node C and Output Port (#10)

Furthermore, the intra-VPN broadcasting unit 12 copies and transmits the frame to three output destinations, excluding receiving port #2, of all the obtained output destinations in the VPN#200.

Frame Output (Edge Node A)

The unit 12 transmits the frame to all the obtained output destinations. In this case, if the output destination is a local port, the frame is transmitted without performing any other process. If the output destination is an LSP, the label addition unit 9 attaches a label to the top of the frame and transmits the frame.

MPLS Frame Rely Process in MPLS Relay Node:

The relay process in an MPLS network of a frame transmitted to the port#1 of edge node B is described below.

Relay of Frame with Label (Nodes ab1 and ab2)

As in the existing MPLS relay process, an MPLS relay node ab1 on the way between edge nodes refers to the label table 10 of the node using the label forwarding unit 11, as a result, replaces a label in the first Shim header with (ab2) and transmits the frame from port#1 to node ab2.

Similarly, an MPLS relay node ab2 on the way between edge nodes refers to the label table 10 of the node using the label forwarding unit 11, as a result, deletes the first Shim header (Shim header, including a label value ab2) and transmits the frame from port#1 to node B.

MPLS Frame Relay Process in Exit Node (Edge Node B):

Frame relay in exit node B is described below.

Label Forwarding Unit (Edge Node B)

Upon receipt of a frame from the port of an MPLS network accommodation unit, edge node B refers to the label table 10 using the label forwarding unit 11, as a result, deletes the first Shim header and also transmits the frame from output port#1.

By applying the processes described above to all the copied frames as broadcasting destinations in VPN#200, frame broadcasting in VPN#200 can be implemented.

Next, a relay process in the case where edge node B receives a MAC frame transmitted from a user network #200-2-1, from port#1 in response to the frame transmitted from a user network #200-1, is described.

Address of this MAC Frame:

Transmission destination MAC:00:bb:aa:00:00:02

Transmission source MAC:00:aa:bb:00:00:01

MPLS Frame Relay Process in Entrance Node (Edge Node B)

Upon receipt of a frame from the port of a line accommodation unit, edge node B relays the frame in a forwarding plane as follows using both the L2 forwarding unit 31 and label addition unit 9.

L2 forwarding unit (edge node B)

Identification of VPN Corresponding to Receiving Port

The unit obtains a VPN#200 as the identifier of a VPN corresponding to receiving port#1 from the VPN definition table 3.

Route Learning Check about Transmission Source MAC

The unit retrieves data from an L2 route table 21 for VPN#200 using the transmission source MAC of the frame as a key.

If the retrieval hits, the unit proceeds to a subsequent process without performing any other operation. However, in this case, since a route for MAC address 00:aa:bb:00:00:01 has not been yet registered in the L2 route table 21 and thereby the retrieval mishits. Therefore, as in the route learning check about transmission source MAC, the route registration unit 8 registers a route for the transmission source MAC in the L2 route tables 21 for each port belonging to the VPN.

Address Retrieval

The unit retrieves data from the L2 route table 21 for VPN#200 using the transmission destination MAC of the frame as a key.

If the retrieval hits, the unit obtains the local port of an output destination or information about edge connection LSP/VPN connection LSP4. If the retrieval mishits, the unit transfers the frame to the intra-VPN broadcasting unit 12.

In this case, since an MAC address 00:bb:aa:00:00:02 is already registered in an L2 route table 21, the retrieval hits. Therefore, the unit obtains both information about the edge connection LSP of an output destination (label value ba1 and output port #10) and information about VPN connection LSP20.

Frame Output (Edge Node B)

The unit 12 transmits the frame to the obtained output destination. In this case, if the output destination is a local port, the unit transmits the frame without performing any other process. If the output destination is an LSP, the label addition unit 9 attaches a label to the top of the frame and transmits the frame. In this example, since the output destination is an LSP, the unit attaches a Shim header before a layer 2 header.

MPLS Frame Relay Process in MPLS Relay Node:

Relay of Frame with Label (Nodes ba1 and ba2)

As in the frame relay with a label(nodes ab1 and ab2), each of MPLS relay nodes ba1 and ba2 on the way between edge nodes deletes the first Shim header by the existing MPLS relay process and transmits the frame to node A.

MPLS Frame Relay Process in Exit Node (Edge Node A):

Label Forwarding Unit (Edge Node A)

Upon receipt of the frame from the port of an MPLS network accommodation unit, edge node B refers to the label table 10 using the label forwarding unit 11, as a result, deletes the first Shim header and also obtains a corresponding output port.

As described above, the system of the present invention can perform address learning by a transmission source MAC, route determination by a transmission destination MAC and broadcasting within the VPN at the time of transmission destination MAC non-learning, and a layer 2-VPN can be organized.

Since the forwarding plane process is a simple process for referring to a table using the parameter with a fixed length of the frame and performing both direction determination and header addition/deletion, the speed of the process can be easily improved.

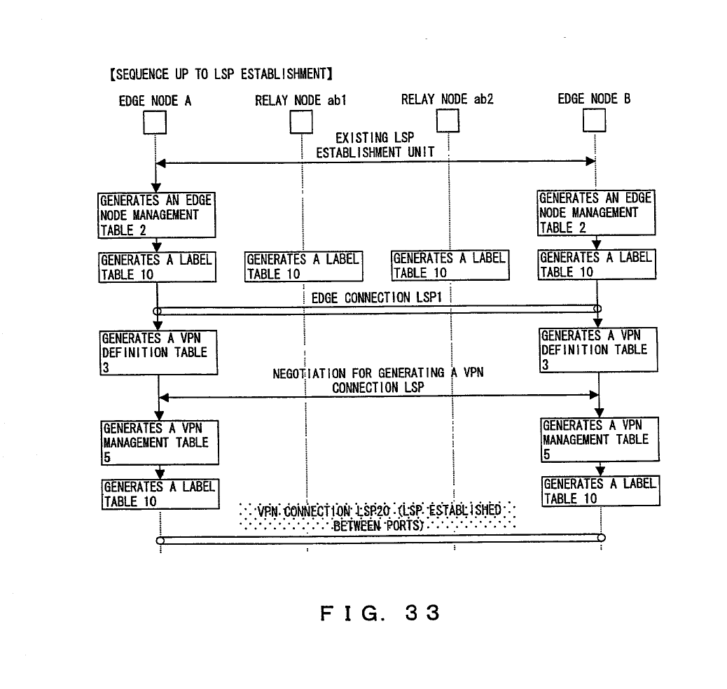

FIG. 33 is a sequence chart showing a process up to the establishment of an LSP in a specific example of the third preferred embodiment.

In this example, it is assumed that relay nodes ab1 and ab2 are installed between edge nodes A and B. First, each of edge nodes A and B starts an existing LSP establishment unit. Then, each of nodes A and B generates an edge node management table 2. Then, each of both edge nodes A/B and relay nodes ab1/ab2 generates a label table 10. In this way, an edge connection LSP1 is established between edge nodes A and B.

Then, each of edge nodes A and B generates a VPN definition table 3, and edge nodes A and B negotiate to establish a VPN connection LSP. Then, each of edge nodes A and B further generates a VPN management table 5. Then, each of both edge nodes A/B and relay nodes ab1/ab2 generates a label table 10. By each node generating a label table 10, a VPN connection LSP20 is established. This VPN connection 20 connects the port of edge node A and the port of edge node B.

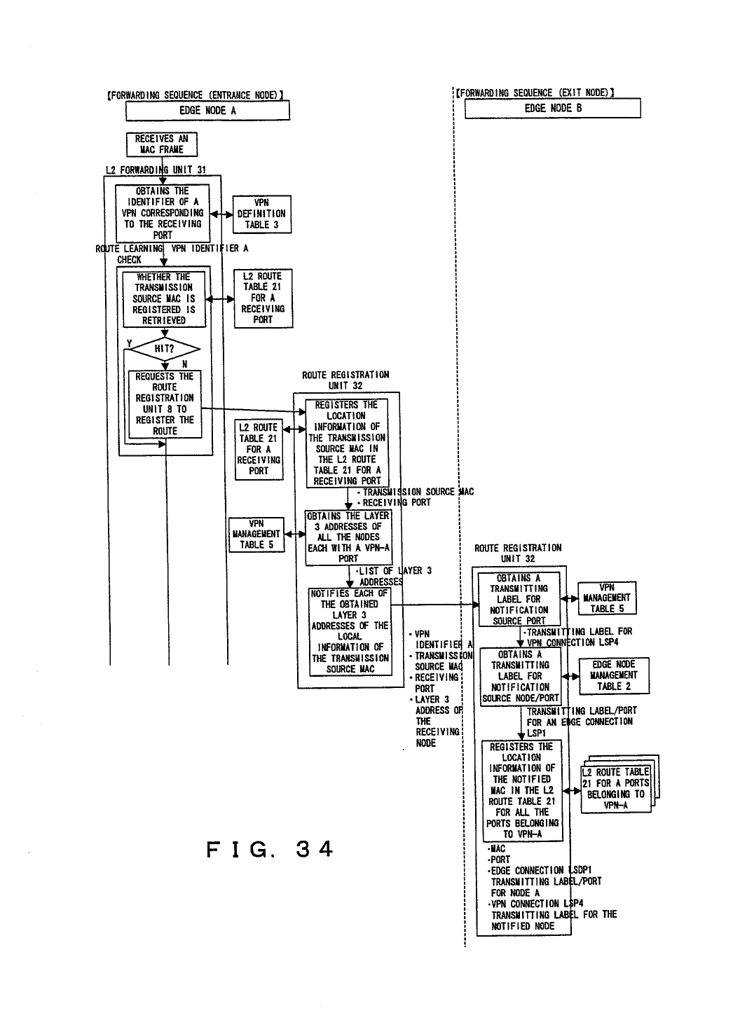

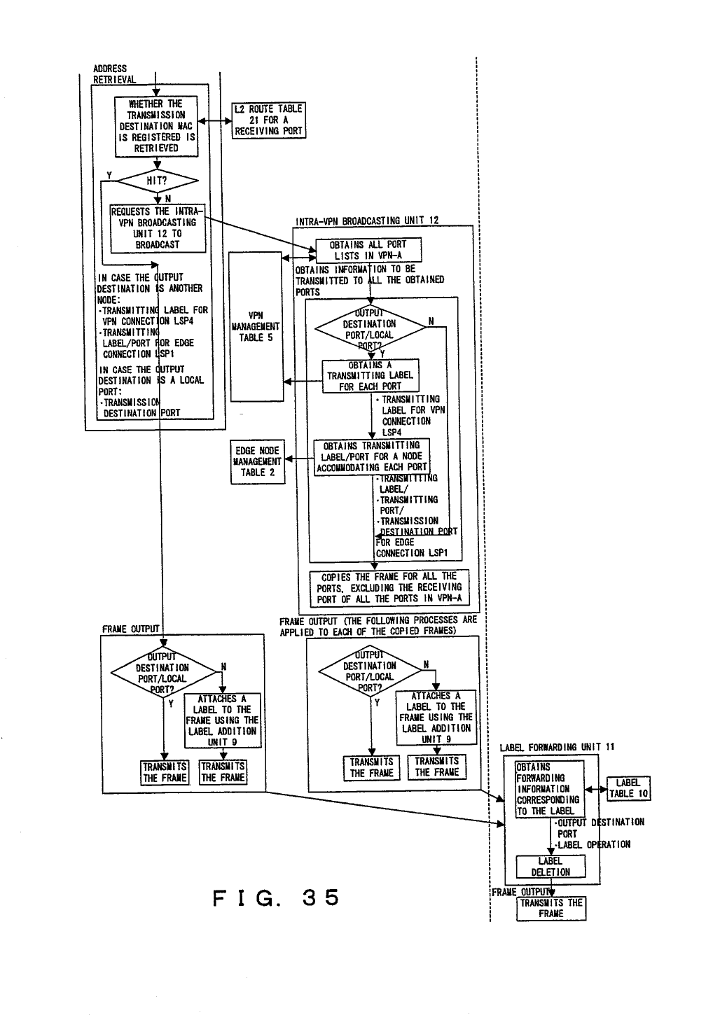

FIGS. 34 and 35 show sequence charts showing frame forwarding.

First, when edge node A, which is an entrance node, receives an MAC frame, an L2 forwarding unit 31 obtains the identifier of a VPN corresponding to the receiving port by referring to the VPN definition table 3. In this example, the VPN identifier is assumed to be A. Then, the flow proceeds to route learning check. In route learning check, first, it is retrieved whether the transmission source MAC is already registered by referring to an L2 route table 2 for a receiving port. If the retrieval hits, the flow proceeds to address retrieval. If the retrieval mishits, a route registration request is issued to the route registration unit 32 and then the flow proceeds to address retrieval.

The route registration unit 32 registers the location information of the transmission source MAC in the L2 route table 21 for a receiving port. In this case, both the transmission source MAC and receiving port are registered. Then, the unit 32 obtains the layer 3 addresses of all the nodes with a port in VPN-A. In this case, a list of layer 3 addresses is generated. The unit 32 notifies each of the obtained layer 3 addresses of the location information of the transmission source MAC. In this case, the notice includes the VPN identification A, a transmission source MAC, a receiving port and the layer 3 address of a receiving node.

Upon receipt of the notice, an exit node obtains a transmitting label for a notification source port from the VPN management table 5 using the route registration unit 32. Specifically, a transmitting label for a VPN connection LSP20 is obtained. The unit 32 further obtains transmitting label/port for a notification source from the edge node management table 2. In this case, both a transmitting label for an edge connection LSP1 and a transmitting port are obtained. Then, the unit 32 registers the location information of an MAC that is notified to an L2 route table 21 for all the ports belonging to VPN-A, in an L2 route table 21 for VPN-A. In this case, an MAC, a port, an edge connection 1 transmitting label for node A, a transmitting port and a VPN connection LSP20 transmission label for a notified port are registered.

In edge node A, in address retrieval it is retrieved whether the transmission destination MAC is already registered, by referring to an L2 route table 21 for a receiving port. If the retrieval hits, the flow proceeds to frame output. If in frame output, the output destination is another node, a transmission label for a VPN connection LSP20, a transmitting label for an edge connection LSP1 and a transmitting port are determined. If the output destination is a local port, a transmitting port is determined.

If in the retrieval of whether the transmission destination MAC is already registered, it is judged that the retrieval mishits, a broadcasting request is issued to the intra-VPN broadcasting unit 12. The intra-VPN broadcasting unit 12 obtains all the port lists in VPN-A from the VPN management table 5 and obtains transmission information about the obtained all ports. Specifically, the unit 12 judges whether the output destination port is a local port, for each output port. If the output destination port is a local port, the unit 12 obtains a transmitting destination port as transmission information. If the output destination port is not a local port, the unit 12 obtains a VPN connection LSP20 transmitting label for the port from the VPN management table 5 as transmission information and further obtains transmitting label/port for a node accommodating each port by referring to the edge node management table 2. This obtained information includes a transmitting label for an edge connection LSP1, a transmitting port and a transmitting destination port. Then, after obtaining transmission information about all the ports, the unit 12 copies the frame for all the ports in VPN-A. Then, the flow proceeds to frame output.

In frame output it is judged whether the output destination port of a frame to be transmitted is a local port. If the output destination is a local port, the unit 12 transmits the frame. If the output destination is not a local port, the label addition unit 9 attaches a label to a frame and transmits the frame.

Upon receipt of the frame, an exit node obtains information about forwarding corresponding to the label from the label table 10 using the label forwarding unit 11. Specifically, the unit 11 obtains an output destination port and performs a label operation. Then, the unit 12 deletes the unnecessary label and transmits the frame.

The L2 label tables of the first and second preferred embodiments of all the L2 label tables described above are different in that the first preferred embodiment has an L2 route table in units of an VPN identifier, while the second preferred embodiment has an L2 route table in units of a port.

This difference is due to the fact that in the former, an LSP is established between a line accommodation unit and a port, while in the latter, an LSP is established between ports. Specifically, although in either case, an address retrieval process determines an address by referring to an L2 route table.

In the latter, the system must have an LSP in units of a port since the address of an LSP varies depending on a receiving port even if the transmission destination port is the same.

While in the former, it is acceptable if the system has an LSP in units of a VPN since a transmission destination LSP can be specified only if the number of a VPN to which a received frame belongs is known.

Although in the first through third preferred embodiments, a local relay process is performed within an edge node without attaching a label, in order to unify a label addition/deletion process regardless of whether the relay is local relay or relay between nodes, an L2 label can also be temporarily attached within the device in local relay and the L2 label can also be deleted before transmission. Alternatively, in local relay, the same LSP as that of relay between nodes can be established (specifically, in the first preferred embodiment, a VPN connection LSP can be established between the line accommodation unit and a port of one device, while in the second and third preferred embodiments, an VPN connection LSP can be established between ports of one device).

Although in the first through third preferred embodiments, VPN broadcasting is performed in an entrance node, in order to reduce the process load of an entrance node, for example, another node (for example, a special node for exclusively performing a broadcasting process) can also be prepared and the node can also perform the broadcasting process.

Although in the second preferred embodiment, an entrance/exit route registration unit registers routing information only in an L2 route table for a receiving port, routing information can also be registered not only in the table for a receiving port but also in a table for all the ports of the device, of all the ports in the same VPN as a receiving VPN. Specifically, the entrance/exit route registration unit can also perform not only registration in an L2 route table for a receiving port, but also the following processes.

The unit obtains all the ports in the same VPN as a receiving VPN.

The unit extracts a list of all ports in the VPN of the device.

The unit registers routing information in an L2 route table for these ports.

In the first through third preferred embodiments, the flow proceeds in the following order.

1. Route learning

2. Address retrieval

However, the order can also be reversed. Specifically, the flow can also proceeds in the following order.

1. Address retrieval

2. Route learning

Although in the fourth, fifth and sixth preferred embodiments, an entrance edge node attaches a Shim header to a frame with a VLAN header received from a user network and transmits up to an exit edge node without performing any other process, in order to save a band by reducing a header length in an MPLS network, the entrance can also delete the VLAN header and the exit edge node can also attach the VLAN header again.

In the fourth, fifth and sixth preferred embodiments, in order to connect VLAN networks each with a different VID allocated, an entrance edge node can also delete a VLAN header from a frame with a VLAN header received from a user network and an exit edge node can also attach a VLAN header, including a VID allocated to a connection destination VLAN network, again.

Alternatively, an entrance edge node can attach a Shim header to a frame with a VLAN header received from a user without deleting the VLAN header from the frame and transmit the frame up to the exit edge node, while the exit edge node can also replace the VID (field) of the VLAN header with a VID allocated to a connection destination VLAN network.

According to the present invention, by connecting user networks connected by a VPN using an existing MPLS network and replacing the edge nodes with the edge nodes of the present invention, a layer 2-VPN network can be organized. The layer 2-VPN network can also perform address learning by a relay bridge relay transmission source MAC, route determination by an address MAC and broadcasting within a VPN at the time of address MAC non-determination.

Since the forwarding plane process is a simple process for referring to a table using the parameter with a fixed length of the frame and performing both direction determination and header addition/deletion, the speed of the process can be easily improved.

What is claimed is:

1. A relay system for connecting first and second layer 2 networks (Virtual Private Network) through a public network and relaying frames, comprising:
a connection establishment unit relating the first layer 2 network to the second layer 2 network and establishing an MPLS connection;
a storage unit storing correspondence between the first layer 2 network connected to the system and the MPLS connection when receiving a frame from the first layer 2 network;
a transmitting unit obtaining an MPLS connection from the storage unit, and transmitting a frame upon receipt of the frame from the first layer 2 network; and
a broadcasting unit broadcasting the frame if an MPLS connection corresponding to the frame received from the first layer 2 network is not stored in the storage unit.

2. The relay system according to claim 1, wherein calling either a physical interface or a logical interface a port, the MPLS connection is established between a line accommodation unit of a relay system to which the first layer 2 network is connected and an output port of a relay system to which the second layer 2 network is connected.

3. The relay system according to claim 1, wherein calling either a physical interface or a logical interface a port, the MPLS connection is established between a line accommodation unit accommodating a first VLAN and a logical port accommodating a second VLAN.

4. The relay system according to claim 1, wherein calling either a physical interface or a logical interface a port, the MPLS connection is established between an input port of a relay system to which the first layer 2 network is connected and an output port of a relay system to which the second layer 2 network.

5. The relay system according to claim 1, wherein calling either a physical interface or a logical interface a port, correspondence between a transmission source address in a frame and a receiving port is registered in storage information of the storage unit corresponding to a layer 2 network identified upon receipt of the frame, simultaneously the correspondence is notified to all edge nodes each with a port corresponding to the layer 2 network in the public network and the correspondence between the transmission source address and the MPLS connection for the receiving port is registered.

6. The relay system according to claim 1, wherein calling either a physical interface or a logical interface a port, upon receipt of a frame from an MPLS connection, a transmission source address in the frame and an MPLS connection having a transmission destination and a transmission source as a transmission source port of the connection and an output destination port of the connection, respectively, are related and registered.

7. The relay system according to claim 1, which upon receipt of a frame from the public network, obtains an output destination corresponding to a label in the frame, deletes the label and transmits the frame.

8. The relay system according to claim 1, wherein if the first layer 2 network and the second layer 2 network are both operated in a VLAN stipulated by IEEE802.1Q (IEEE802.1Q Virtual LAN) and if either a physical interface or a logical interface is called a port, the MPLS connection is established between a logical port accommodating the first VLAN and a logical port accommodating the second VLAN.

9. The relay system according to claim 1, wherein the public network is an MPLS network.

10. The relay system according to claim 1, wherein the frame is an MAC frame.

11. A relay method for connecting first and second layer 2 networks (Virtual Private Network) through a public network and relaying frames, comprising:
relating the first layer 2 network to the second layer 2 network and establishing an MPLS connection;
storing correspondence between the first layer 2 network connected to the system and the MPLS connection when receiving a frame from the first layer 2 network;
obtaining an MPLS connection from the storage unit, and transmitting a frame upon receipt of the frame from the first layer 2 network; and
broadcasting the frame if an MPLS connection corresponding to the frame received from the first layer 2 network is not stored in the storage unit.

12. The relay method according to claim 11, wherein calling either a physical interface or a logical interface a port, the MPLS connection is established between a line accommodation unit of a relay system to which the first layer 2 network is connected and an output port of a relay system to which the second layer 2 network is connected.

13. The relay method according to claim 11, wherein calling either a physical interface or a logical interface a port, the MPLS connection is established between a line accommodation unit accommodating a first VLAN and a logical port accommodating a second VLAN.

14. The relay method according to claim 11, wherein calling either a physical interface or a logical interface a port, the MPLS connection is established between an input port of a relay system to which the first layer 2 network is connected and an output port of a relay system to which the second layer 2 network is connected.

15. The relay method according to claim 11, wherein calling either a physical interface or a logical interface a port, correspondence between a transmission source address in a frame and a receiving port is registered in storage information of the storage unit corresponding to a layer 2 network identified upon receipt of the frame and simultaneously, the correspondence is notified to all edge nodes each with a port corresponding to the layer 2 network in the public network and the correspondence between the transmission source address and the MPLS connection for the receiving port is registered.

16. The relay method according to claim 11, wherein calling either a physical interface or a logical interface a port, upon receipt of a frame from an MPLS connection, a transmission source address in the frame and an MPLS connection having a transmission destination and a transmission source as a transmission source port of the connection and an output destination port of the connection, respectively, are related and registered.

17. The relay method according to claim 11, wherein upon receipt of a frame from the public network, the relay system obtains an output destination corresponding to a label in the frame, deletes the label and transmits the frame.

18. The relay method according to claim 11, wherein if the first layer 2 network and the second layer 2 network are both operated in a VLAN stipulated by IEEE802.1Q (IEEE802.1Q Virtual LAN) and if either a physical interface or a logical interface is called a port, the MPLS connection is established between a logical port accommodating the first VLAN and a logical port accommodating the second VLAN.

19. The relay method according to claim 11, wherein the public network is an MPLS network.

20. The relay method according to claim 11, wherein the frame is an MAC frame.
